(19) United States
(12) Patent Application Publication
(10) Pub. No.: US 2010/0309174 A1
(43) Pub. Date: Dec. 9, 2010

(54) DISPLAY DEVICE, DRIVING METHOD OF DISPLAY DEVICE, AND ELECTRONIC DEVICE PERFORMING DUTY CONTROL OF A PIXEL

(75) Inventors: Masatsugu Tomida, Kanagawa (JP); Katsuhide Uchino, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/785,559

(22) Filed: May 24, 2010

(30) Foreign Application Priority Data
Jun. 3, 2009 (JP) 2009-133607

(51) Int. Cl. G09G 5/00

(52) U.S. Cl. 345/204

(57) ABSTRACT

A display device capable of controlling the emission period of pixels of a display screen individually pixel by pixel. In some embodiments, there is provided an apparatus comprising a display screen and at least one driving circuit. The display screen comprises a plurality of pixels. Each pixel comprises a light-emitting element and a control circuit to receive an input having a value that sets a time period for which the light-emitting element is to emit light and to control the light-emitting element to emit light for the time period. The at least one driving circuit is adapted to control the plurality of pixels to emit light by providing to each pixel a signal having a value that sets a length of time for which the pixel is to emit light. The signal value for a first pixel is different from the signal value for a second pixel.

### BACKGROUND OF THE INVENTION

1. Field of the Invention

Embodiments of the present invention relate to a display device, a driving method of a display device, and an electronic device, and particularly to a plane type (flat panel type) display device in which pixels including an electrooptic element are arranged two-dimensionally in the form of a matrix, a driving method of the display device, and an electronic device having the display device, in which duty control of a pixel is performed.

2. Description of the Related Art

Recently, plane type display devices formed by arranging pixels (pixel circuits) in the form of a matrix have spread rapidly in a field of display devices for displaying an image. As one of the plane type display devices, there is a display device using a so-called current-driven type electrooptic element changing in light emission luminance according to the value of a current flowing in the device as a light emitting element of a pixel. An organic EL (Electro Luminescence) element utilizing a phenomenon of light being emitted when an electric field is applied to an organic thin film is known as a current-driven type electrooptic element.

An organic EL display device using the organic EL element as an electrooptic element of a pixel has the following features. The organic EL element can be driven by an application voltage of 10 V or lower, and thus consumes low power. Because the organic EL element is a self-luminous element, as compared with a liquid crystal display device that displays an image by controlling the intensity of light from a light source in a liquid crystal in each pixel, the organic EL display device provides high image visibility, and is easily reduced in weight and thickness because an illuminating member such as a backlight or the like is not required. Further, because the organic EL element has a very high response speed of a few μsec or so, no afterimage occurs at a time of displaying a moving image.

As with the liquid crystal display device, the organic EL display device can adopt a simple (passive) matrix system and an active matrix system as a driving system of the organic EL display device. However, while having a simple structure, a simple matrix type display device presents for example a problem of difficulty in realizing a large and high-definition display device because the emission period of an electrooptic element is reduced by an increase in the number of scanning lines (that is, the number of pixels).

Therefore an active matrix type display device that controls current flowing through an electrooptic element by an active element, for example an insulated gate field effect transistor provided within a same pixel as the electrooptic element has recently been actively developed. A TFT (Thin Film Transistor) is typically used as the insulated gate field effect transistor. The active matrix type display device makes it easy to realize a large and high-definition display device because the electrooptic element continues emitting light over the period of one frame.

It is generally known that the I-V characteristic (current-voltage characteristic) of the organic EL element is degraded with the passage of time (so-called secular degradation). In a pixel circuit using an N-channel type TFT in particular as a transistor that current-drives an organic EL element (which transistor will hereinafter be described as a “driving transistor”), when the I-V characteristic of the organic EL element is degraded with the passage of time, the gate-to-source voltage Vgs of the driving transistor changes. As a result, the light emission luminance of the organic EL element changes. This is because the organic EL element is connected to the source electrode side of the driving transistor.

This will be described more specifically. The source potential of the driving transistor is determined by an operating point of the driving transistor and the organic EL element. When the I-V characteristic of the organic EL element is degraded, the operating point of the driving transistor and the organic EL element varies. Thus, even when a same voltage is applied to the gate electrode of the driving transistor, the source potential of the driving transistor changes. Thereby, the gate-to-source voltage Vgs of the driving transistor changes, and therefore the value of current flowing through the driving transistor changes. As a result, the value of current flowing through the organic EL element also changes, so that the light emission luminance of the organic EL element changes.

Further, in a pixel circuit using a polysilicon TFT in particular, in addition to a secular degradation in the I-V characteristic of an organic EL element, transistor characteristics of a driving transistor change with the passage of time, and the transistor characteristics differ in each pixel due to variations in a manufacturing process. That is, there is variation in transistor characteristics of the driving transistor in each individual pixel. The transistor characteristics include the threshold voltage Vth of the driving transistor, the mobility μ of a semiconductor thin film forming a channel of the driving transistor (which mobility will hereinafter be referred to simply as the “mobility μ of the driving transistor”), and the like.

When the transistor characteristics of the driving transistor differ in each pixel, the value of current flowing through the driving transistor varies in each pixel. Thus, even when a same voltage shared between pixels is applied to the gate electrode of the driving transistor, the light emission luminance of the organic EL element varies between the pixels. As a result, screen uniformity is impaired.

Accordingly, in order to hold the light emission luminance of the organic EL element constant without being affected by a secular degradation in the I-V characteristic of the organic EL element or a secular change in the transistor characteristics of the driving transistor, various correcting (compensating) functions are provided to the pixel circuit (see Japanese Patent Laid-Open No. 2006-133542, hereinafter referred to as Patent Document 1, for example).

The correcting functions include a compensating function for variation in characteristics of the organic EL element, a correcting function for variation in the threshold voltage Vth of the driving transistor, a correcting function for variation in mobility μ of the driving transistor, and the like. Correction for variation in threshold voltage Vth of the driving transistor will hereinafter be referred to as “threshold value correction”. Correction for variation in mobility μ of the driving transistor will hereinafter be referred to as “mobility correction”.

A display device described in Patent Document 1 employs a configuration in which a switching transistor is connected in series with a driving transistor and the emission period of an organic EL element is controlled by on/off operation of the switching transistor. However, the emission period control according to the technique in Patent Document 1 is performed uniformly over an entire screen.

On the other hand, a technique has been proposed which makes an emission period differ between pixels by blunting the rising edge waveform of a control signal defining the emission period within one frame period in an emissive display device such as an organic EL display device or the like (see Japanese Patent Laid-Open No. 2008-102223, hereinafter referred to as Patent Document 2, for example).

### SUMMARY OF THE INVENTION

However, the technique according to the foregoing Patent Document 2 blunts the rising edge waveform of the control signal defining the emission period within one frame period in order to suppress a so-called burn-in caused by degradation in an organic EL element (light emitting element). Therefore, differences in emission period between pixels depend on a degree of degradation of the organic EL element in each pixel. That is, the emission period is autonomously optimized according to a degree of degradation of the organic EL element in each pixel, and the technique does not control the emission period individually pixel by pixel.

It is accordingly desirable to provide a display device capable of controlling the emission period individually pixel by pixel, a driving method of the display device, and an electronic device having the display device.

In some embodiments, there is provided an apparatus comprising a pixel to emit light. The pixel comprises a light-emitting element and a control circuit to receive an input having a value that sets a time period for which the light-emitting element is to emit light and to control the light-emitting element to emit light for the time period.

In some embodiments, there is provided an apparatus comprising a driving circuit to control a plurality of pixels of a display screen to emit light. The driving circuit provides to each pixel a signal having a value that sets a length of time for which the pixel is to emit light, wherein the signal value for a first pixel is different from the signal value for a second pixel.

In one particular implementation of this embodiment, the driving circuit may be implemented as a controlling circuit.

In some embodiments, there is provided an apparatus comprising a display screen and at least one driving circuit. The display screen comprises a plurality of pixels. Each pixel of the plurality of pixels comprises a light-emitting element to emit light. The at least one driving circuit is adapted to control the plurality of pixels to emit light by providing to each pixel a signal having a value that sets a length of time for which the pixel is to emit light. The signal value for a first pixel is different from the signal value for a second pixel.

In some embodiments, there is provided an electronic device for displaying visual content to a user. The electronic device comprises a display screen and at least one driving circuit. The display screen comprises a plurality of pixels. Each pixel of the plurality of pixels comprises a light-emitting element to emit light. The at least one driving circuit is adapted to control the plurality of pixels to emit light by providing to each pixel a signal having a value that sets a length of time for which the pixel is to emit light. The signal value for a first pixel is different from the signal value for a second pixel.

In particular implementations of this embodiment, the electronic device may be implemented as a television, a digital camera, a computer, a video camera, or a mobile device, or any other suitable device.

In some embodiments, there is provided a method of operating a pixel to emit light. The method comprises receiving, at the pixel, a first input signaling that light is to be emitted and a second input having a value that sets a time period during which to emit light and, in response to the first input, emitting light from a light-emitting element of the pixel. The method further comprises, following the time period, ceasing to emit light from the light-emitting element.

In some embodiments, there is provided a method of displaying an image on a display device comprising a plurality of pixels. The method comprises operating a set of pixels of the display device to emit light. Operating the set comprises configuring a first pixel of the set to emit light for a first time period, configuring a second pixel of the set to emit light for a second time period, and controlling each pixel of the set of pixels to emit light. In the configuring, the first time period is different from the second time period.

In a display device of the above-described configurations, the emission period of the electrooptic element can be controlled by on/off operation of the light emission controlling transistor connected in series with the driving transistor. At this time, the gate potential of the light emission controlling transistor varies when the charge based on the light emission period controlling signal written by the second writing transistor and retained in the second storage capacitor is discharged through a discharging path. A varying time until the gate potential reaches a potential at which the light emission controlling transistor is set in a non-conducting state is determined by the light emission period controlling signal for controlling the emission period of the electrooptic element pixel by pixel, and the emission period of the electrooptic element is determined by the light emission period controlling signal. Thereby, the emission period of the electrooptic element can be controlled individually pixel by pixel according to the light emission period controlling signal.

According to embodiments of the present invention, because the emission period of the electrooptic element can be controlled individually pixel by pixel, novel image control that cannot be expected when the emission period is controlled uniformly over an entire screen can be performed.

### BRIEF DESCRIPTION OF THE DRAWINGS

FIG. 1 is a system configuration diagram showing an outline of configuration of an active matrix type display device according to a first embodiment of the present invention;

FIG. 2 is a circuit diagram showing a concrete circuit configuration of a pixel (pixel circuit) according to the first embodiment;

FIG. 3 is a timing waveform chart of assistance in explaining a circuit operation of an organic EL display device according to the first embodiment;

FIG. 4 is a characteristic diagram of assistance in explaining a problem caused by variation in threshold voltage Vth of a driving transistor;

FIG. 5 is a characteristic diagram of assistance in explaining a problem caused by variation in mobility μ of a driving transistor;

FIGS. 6A, 6B, and 6C are characteristic diagrams of assistance in explaining relations between the signal voltage Vsig of a video signal and the drain-to-source current Ids of a driving transistor according to whether threshold value correction and mobility correction are performed or not;

FIG. 7 is a timing waveform chart of assistance in explaining a circuit operation of an organic EL display device according to a first example of modification of the first embodiment;

FIG. 8 is a circuit diagram showing a pixel circuit of an organic EL display device according to a second example of modification of the first embodiment;

FIG. 9 is a timing waveform chart of assistance in explaining a circuit operation of the organic EL display device according to the second example of modification;

FIG. 10 is a circuit diagram showing a pixel circuit of an organic EL display device according to a third example of modification of the first embodiment;

FIG. 11 is a circuit diagram showing a pixel circuit of an organic EL display device according to a fourth example of modification of the first embodiment;

FIG. 12 is a system configuration diagram showing an outline of configuration of an active matrix type display device according to a second embodiment of the present invention;

FIG. 13 is a circuit diagram showing a concrete circuit configuration of a pixel (pixel circuit) according to the second embodiment;

FIG. 14 is a timing waveform chart of assistance in explaining a circuit operation of an organic EL display device according to the second embodiment;

FIG. 15 is a perspective view of an external appearance of a television set to which one embodiment of the present invention is applied;

FIGS. 16A and 16B are perspective views of an external appearance of a digital camera to which one embodiment of the present invention is applied, FIG. 16A being a perspective view of the digital camera as viewed from a front side, and FIG. 16B being a perspective view of the digital camera as viewed from a back side;

FIG. 17 is a perspective view of an external appearance of a notebook personal computer to which one embodiment of the present invention is applied;

FIG. 18 is a perspective view of an external appearance of a video camera to which one embodiment of the present invention is applied; and

FIGS. 19A, 19B, 19C, 19D, 19E, 19F, and 19G are external views of a portable telephone to which one embodiment of the present invention is applied, FIG. 19A being a front view of the portable telephone in an opened state, FIG. 19B being a side view of the portable telephone in the opened state, FIG. 19C being a front view of the portable telephone in a closed state, FIG. 19D being a left side view, FIG. 19E being a right side view, FIG. 19F being a top view, and FIG. 19G being a bottom view.

### DETAILED DESCRIPTION OF THE PREFERRED EMBODIMENTS

The mode for carrying out embodiments of the invention (which mode will hereinafter be described as “embodiments”) will hereinafter be described in detail with reference to the drawings. Incidentally, description will be made in the following order.

1. First Embodiment (Example of VCCP Assuming Two Values VCCP_Hi and VCCP_Low)

1-1. System Configuration

1-2. Circuit Operation

1-3. Examples of Modification

2. Second Embodiment (Example Having Correcting Switching Transistor)

2-1. System Configuration

2-2. Circuit Operation

3. Examples of Modification

4. Examples of Application (Electronic Devices)

### 1. First Embodiment

### 1-1. System Configuration

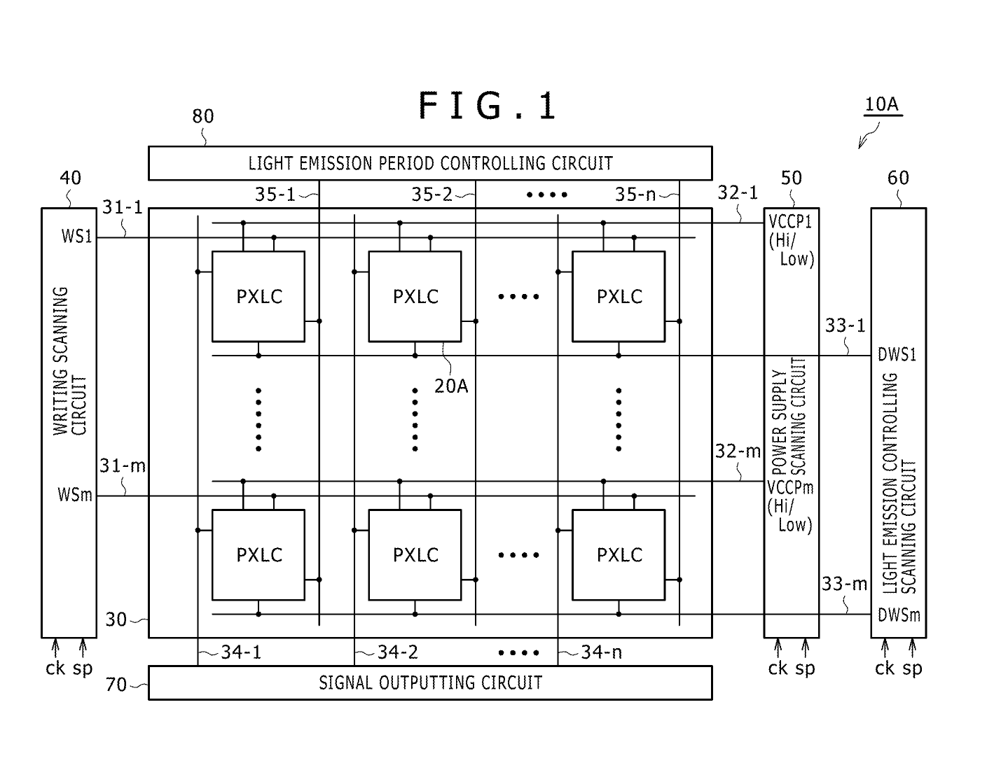

FIG. 1 is a system configuration diagram showing an outline of configuration of an active matrix type display device according to a first embodiment of the present invention.

Description in the following will be made by taking as an example a case of an active matrix type organic EL display device using a current-driven type electrooptic element changing in light emission luminance according to the value of a current flowing in a device, which electrooptic element is for example an organic EL element, as a light emitting element of a pixel (pixel circuit).

As shown in FIG. 1, the organic EL display device 10A according to the first embodiment includes a plurality of pixels 20A including the organic EL element, a pixel array section 30 in which the pixels 20A are arranged two-dimensionally in the form of a matrix, and a driving section disposed on the periphery of the pixel array section 30. The driving section on the periphery of the pixel array section 30 includes a writing scanning circuit 40, a power supply scanning circuit 50, a light emission controlling scanning circuit 60, a signal outputting circuit 70, a light emission period controlling circuit 80 and the like. The driving section drives each pixel 20A of the pixel array section 30.

In a case where the organic EL display device 10A is capable of color display, one pixel is formed of a plurality of sub-pixels, and the sub-pixels correspond to pixels 20A. More specifically, in a display device for color display, one pixel is formed of three sub-pixels, that is, a sub-pixel emitting red light (R), a sub-pixel emitting green light (G), and a sub-pixel emitting blue light (B).

However, one pixel is not limited to the combination of sub-pixels of the three primary colors of RGB, but one pixel may be formed by further adding a sub-pixel of one color or sub-pixels of a plurality of colors to sub-pixels of the three primary colors. More specifically, for example, one pixel can be formed by adding a sub-pixel emitting white light (W) to improve luminance, or one pixel may be formed by adding at least one sub-pixel emitting light of a complementary color to extend a range of color reproduction.

In the pixel array section 30, scanning lines 31-1 to 31-m, power supply lines 32-1 to 32-m, and light emission controlling scanning lines 33-1 to 33-m are arranged in each pixel row along a row direction (direction of arrangement of pixels of pixel rows) in an arrangement of pixels 20A of m rows and n columns. Further, video signal lines 34-1 to 34-n and light emission controlling signal lines 35-1 to 35-n are arranged in each pixel column along a column direction (direction of arrangement of pixels of pixel columns).

The scanning lines 31-1 to 31-m are connected to respective output terminals for the corresponding rows of the writing scanning circuit 40. The power supply lines 32-1 to 32-m are connected to respective output terminals for the corresponding rows of the power supply scanning circuit 50. The light emission controlling scanning lines 33-1 to 33-m are connected to respective output terminals for the corresponding rows of the light emission controlling scanning circuit 60. The video signal lines 34-1 to 34-n are connected to respective output terminals for the corresponding columns of the signal outputting circuit 70. The light emission controlling signal lines 35-1 to 35-n are connected to respective output terminals for the corresponding columns of the light emission period controlling circuit 80.

The pixel array section 30 is generally formed on a transparent insulating substrate such as a glass substrate or the like. The organic EL display device 10A thereby has a plane type (flat type) panel structure. A driving circuit of each pixel 20A in the pixel array section 30 can be formed using amorphous silicon TFTs or low-temperature polysilicon TFTs. When low-temperature polysilicon TFTs are used, the writing scanning circuit 40, the power supply scanning circuit 50, the light emission controlling scanning circuit 60, the signal outputting circuit 70, the light emission period controlling circuit 80 and the like can also be mounted on the substrate (display panel) forming the pixel array section 30.

The writing scanning circuit 40 is formed by a shift register or the like that shifts (transfers) a start pulse sp in order in synchronism with a clock pulse ck. In writing a video signal to each pixel 20A of the pixel array section 30, the writing scanning circuit 40 scans each pixel 20A of the pixel array section 30 in order in a row unit (line-sequential scanning) by sequentially outputting a writing scanning signal WS (WS1 to WSm) to the scanning lines 31-1 to 31-m.

The power supply scanning circuit 50 is formed by a shift register or the like that shifts the start pulse sp in order in synchronism with the clock pulse ck. The power supply scanning circuit 50 outputs a power supply potential VCCP (VCCP1 to VCCPm) changing between a first power supply potential VCCP_Hi and a second power supply potential VCCP_Low lower than the first power supply potential VCCP_Hi in synchronism with the line-sequential scanning of the writing scanning circuit 40 to the power supply lines 32-1 to 32-m.

The first power supply potential VCCP_Hi is a power supply potential for supplying a driving current for light emission driving of an organic EL element 21 to a driving transistor 22. The second power supply potential VCCP_Low is a power supply potential for applying a reverse bias to the organic EL element 21. The second power supply potential VCCP_Low is set to be a potential lower than a reference potential Vofs, for example, letting Vth be the threshold voltage of the driving transistor 22, a potential lower than Vofs-Vth, or preferably a potential sufficiently lower than Vofs-Vth.

The light emission controlling scanning circuit 60 is formed by a shift register or the like that shifts the start pulse sp in order in synchronism with the clock pulse ck. In controlling the light emission period of the organic EL element 21 in a pixel unit, the light emission controlling scanning circuit 60 outputs a light emission controlling scanning signal DWS (DWS1 to DWSm) to the light emission controlling scanning lines 33-1 to 33-m in synchronism with the line-sequential scanning of the writing scanning circuit 40.

The signal outputting circuit 70 selectively outputs a signal voltage Vsig of a video signal corresponding to luminance information supplied from a signal supplying source (not shown) (which signal voltage may be described simply as a “signal voltage”) and the reference potential Vofs. In this case, the reference potential Vofs is a voltage serving as a reference for the signal voltage Vsig of the video signal (for example a voltage corresponding to the black level of the video signal).

The signal voltage Vsig/reference potential Vofs output from the signal outputting circuit 70 is written to each pixel 20A of the pixel array section 30 in column units via the video signal lines 34-1 to 34-n. That is, the signal outputting circuit 70 employs a line-sequential writing driving mode in which the signal voltage Vsig is written in column (line) units.

The light emission period controlling circuit 80 outputs the signal voltage Dsig of a light emission period controlling signal for controlling the light emission periods of the pixels 20A pixel by pixel (which signal voltage Dsig may hereinafter be described simply as a “light emission period controlling signal Dsig”) in synchronism with output of the signal voltage Vsig of the video signal from the signal outputting circuit 70. The light emission period controlling signal Dsig output from the light emission period controlling circuit 80 is written to each pixel 20A of the pixel array section 30 in column units via the light emission controlling signal lines 35-1 to 35-n.

### Pixel Circuit

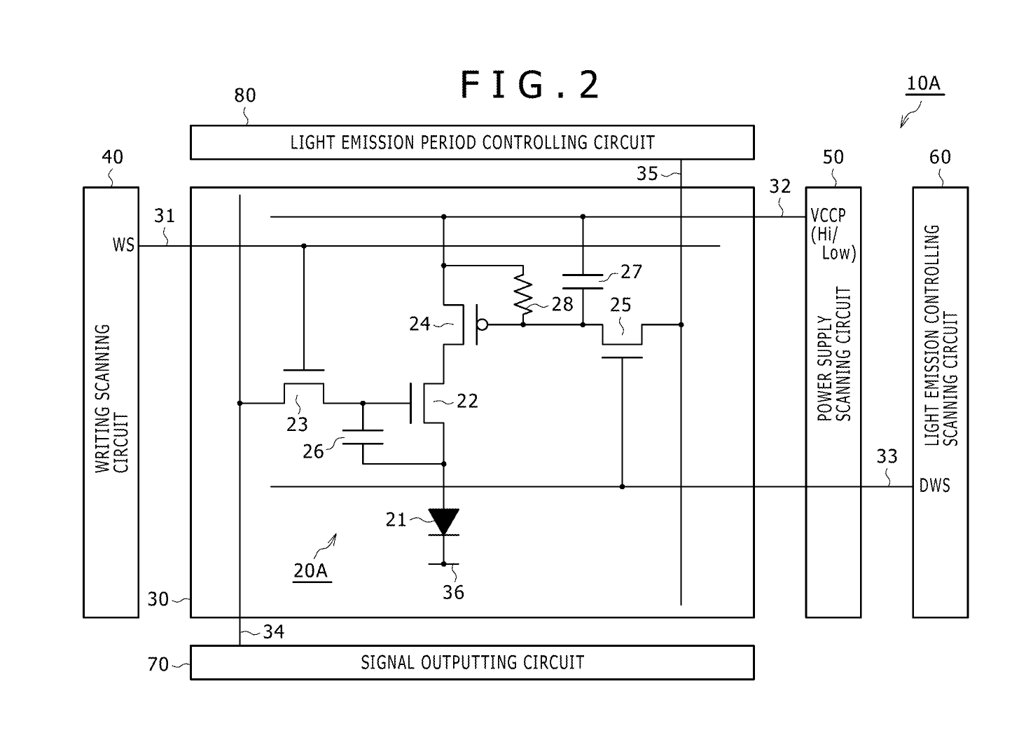

FIG. 2 is a circuit diagram showing a concrete circuit configuration of a pixel (pixel circuit) 20A.

As shown in FIG. 2, the pixel 20A is formed by an organic EL element 21 as a current-driven type electrooptic element changing in light emission luminance according to the value of a current flowing in the device and a driving circuit for driving the organic EL element 21. The organic EL element 21 has a cathode electrode connected to a common power supply line 36 disposed so as to be common to all the pixels 20A (so-called solid wiring).

The driving circuit for driving the organic EL element 21 includes a driving transistor 22, a writing transistor 23 for the video signal, a light emission controlling transistor 24, a writing transistor 25 for a light emission controlling signal, storage capacitors 26 and 27, and an impedance element 28. As the impedance element 28, for example a resistive element (which will hereinafter be described as a “resistive element 28”) can be used.

In this case, an N-channel type TFT is used as the driving transistor 22, the writing transistor 23 for the video signal, and the writing transistor 25 for the light emission controlling signal, and a P-channel type TFT is used as the light emission controlling transistor 24. However, the combination of conductivity types of these transistors 22 to 25 is a mere example, and is not limited to the combination of these conductivity types of the transistors 22 to 25.

The driving transistor 22 has one electrode (source/drain electrode) connected to the anode electrode of the organic EL element 21, and has another electrode (drain/source electrode) connected to a power supply line 32 (32-1 to 32-m).

The writing transistor 23 for the video signal has one electrode (source/drain electrode) connected to a signal line 34 (34-1 to 34-n), and has another electrode (drain/source electrode) connected to the gate electrode of the driving transistor 22. The gate electrode of the writing transistor 23 for the video signal is connected to a scanning line 31 (31-1 to 31-m).

In the driving transistor 22 and the writing transistor 23, the one electrode refers to metallic wiring electrically connected to a source/drain region, and the other electrode refers to metallic wiring electrically connected to a drain/source region. Depending on potential relation between the one electrode and the other electrode, the one electrode is the source electrode or the drain electrode, and the other electrode is the drain electrode or the source electrode.

The light emission controlling transistor 24 has one electrode (source/drain electrode) connected to a power supply line 32 (32-1 to 32-m), and has another electrode (drain/source electrode) connected to the other electrode of the driving transistor 22.

The writing transistor 25 for the light emission controlling signal has one electrode (source/drain electrode) connected to a light emission controlling signal line 35 (35-1 to 35-n), and has another electrode (drain/source electrode) connected to the gate electrode of the light emission controlling transistor 24. The gate electrode of the writing transistor 25 for the light emission controlling signal is connected to a light emission controlling scanning line 33 (33-1 to 33-m).

The storage capacitor 26 has one electrode connected to the gate electrode of the driving transistor 22, and has another electrode connected to the one electrode of the driving transistor 22 and the anode electrode of the organic EL element 21. The storage capacitor 27 has one electrode connected to the gate electrode of the light emission controlling transistor 24, and has another electrode connected to the power supply line 32 (32-1 to 32-m). The resistive element 28 is connected between one electrode (source/drain electrode) and the gate electrode of the light emission controlling transistor 24. The resistive element 28 forms a discharging path for discharging the charge of the storage capacitor 27.

In the pixel 20A of the above-described configuration, the writing transistor 23 for the video signal is set in a conducting state in response to a High-active writing scanning signal WS applied from the writing scanning circuit 40 to the gate electrode of the writing transistor 23 for the video signal through the scanning line 31. Thereby, the writing transistor 23 for the video signal samples the signal voltage Vsig of the video signal corresponding to luminance information or the reference potential Vofs supplied from the signal outputting circuit 70 through the video signal line 34, and writes the signal voltage Vsig or the reference potential Vofs into the pixel 20A. The written signal voltage Vsig or the written reference potential Vofs is applied to the gate electrode of the driving transistor 22, and is retained in the storage capacitor 26.

When the potential VCCP of the power supply line 32 (32-1 to 32-m) is the first power supply potential VCCP_Hi, and the light emission controlling transistor 24 is in a conducting state, the driving transistor 22 operates in a saturation region with the one electrode as a drain electrode and the other electrode as a source electrode. Thereby, the driving transistor 22 is supplied with a current from the power supply line 32 via the light emission controlling transistor 24, and light-emission-drives the organic EL element 21 by current driving. More specifically, the driving transistor 22 operates in the saturation region and thereby supplies a driving current having a current value corresponding to the voltage value of the signal voltage Vsig retained by the storage capacitor 26 to the organic EL element 21 to make the organic EL element 21 emit light by current-driving the organic EL element 21.

The writing transistor 25 for the light emission controlling signal is set in a conducting state in response to a High-active light emission controlling scanning signal DWS applied from the light emission controlling scanning circuit 60 to the gate electrode of the writing transistor 25 for the light emission controlling signal through the light emission controlling scanning line 33. Thereby, the writing transistor 25 for the light emission controlling signal samples the signal voltage Dsig of the light emission period controlling signal supplied from the light emission period controlling circuit 80 through the light emission controlling signal line 35, and writes the signal voltage Dsig into the pixel 20A. The written signal voltage Dsig is applied to the gate electrode of the light emission controlling transistor 24, and is retained in the storage capacitor 27.

Because the signal voltage Dsig of the light emission period controlling signal is written, the gate potential DSgate of the light emission controlling transistor 24 is lowered by the amount of the signal voltage Dsig from the power supply potential VCCP_Hi of the power supply line 32. Therefore the light emission controlling transistor 24 is set in a conducting state. Thereby, the light emission controlling transistor 24 supplies a driving current from the power supply line 32 to the organic EL element 21 via the driving transistor 22, whereby the organic EL element 21 is made to emit light.

When the writing of the signal voltage Dsig by the writing transistor 25 for the light emission controlling signal has been completed, and the writing transistor 25 is set in a non-conducting state, the charge of the storage capacitor 27 is discharged to the power supply line 32 through the discharging path including the resistive element 28. A time constant at this time is determined by the capacitance value of the storage capacitor 27 and the resistance value of the resistive element 28. Incidentally, the impedance element forming the discharging path for discharging the charge of the storage capacitor 27 is not limited to the resistive element 28, but it suffices for the impedance element to be an element capable of forming the discharging path.

The gate potential DSgate of the light emission controlling transistor 24 varies to the power supply potential VCCP_Hi of the power supply line 32 at a varying time (varying speed) determined by the time constant and the signal voltage Dsig of the light emission period controlling signal. Letting DS_Vth be the threshold voltage of the light emission controlling transistor 24, the light emission controlling transistor 24 is set in a non-conducting state at the same time that the gate potential DSgate of the light emission controlling transistor 24 becomes equal to VCCP_Hi−DS_Vth.

Thereby, the supply of the driving current to the organic EL element 21 is interrupted, so that the organic EL element 21 is set in a non-emitting state. At this time, timing of making a transition from an emitting state to a non-emitting state, that is, the length of an emission period is determined according to the varying time of the gate potential DSgate of the light emission controlling transistor 24.

In other words, the varying time until the gate potential DSgate of the light emission controlling transistor 24 reaches a potential at which the light emission controlling transistor 24 is set in a non-conducting state is individually determined, for each pixel, by the signal voltage Dsig of the light emission period controlling signal in each pixel. Then, the emission period of the pixel 20A is determined according to the varying time of the gate potential DSgate of the light emission controlling transistor 24.

Thus, the switching operation of the light emission controlling transistor 24 connected in series with the driving transistor 22 can provide a period during which the organic EL element 21 is set in a non-emitting state (non-emission period), and control a ratio (duty) between the emission period and the non-emission period. This duty control can reduce an afterimage blur attendant on the pixel 20A continuing an emitting state over one frame period, and thus achieve superior image quality of a moving image in particular.

In addition, the timing in which the organic EL element 21 makes a transition from an emitting state to a non-emitting state is determined by the varying speed of the gate potential DSgate of the light emission controlling transistor 24, and the varying speed is determined by the signal voltage Dsig of the light emission period controlling signal. The light emission period of each individual pixel 20A can therefore be controlled by the signal voltage Dsig of the light emission period controlling signal. That is, rather than the light emission period of the pixels 20A being controlled uniformly over the entire screen, the light emission period of each pixel 20A can be controlled by the signal voltage Dsig of the light emission period controlling signal.

Incidentally, in the present circuit example, the light emission controlling transistor 24 is connected between the driving transistor 22 and the power supply line 32 (32-1 to 32-m). However, the light emission controlling transistor 24 can control the emission/non-emission of the organic EL element 21 by being connected in series with the driving transistor 22. Thus, a configuration can also be adopted in which the light emission controlling transistor 24 is connected between the driving transistor 22 and the organic EL element 21, for example.

### 1-2. Circuit Operation

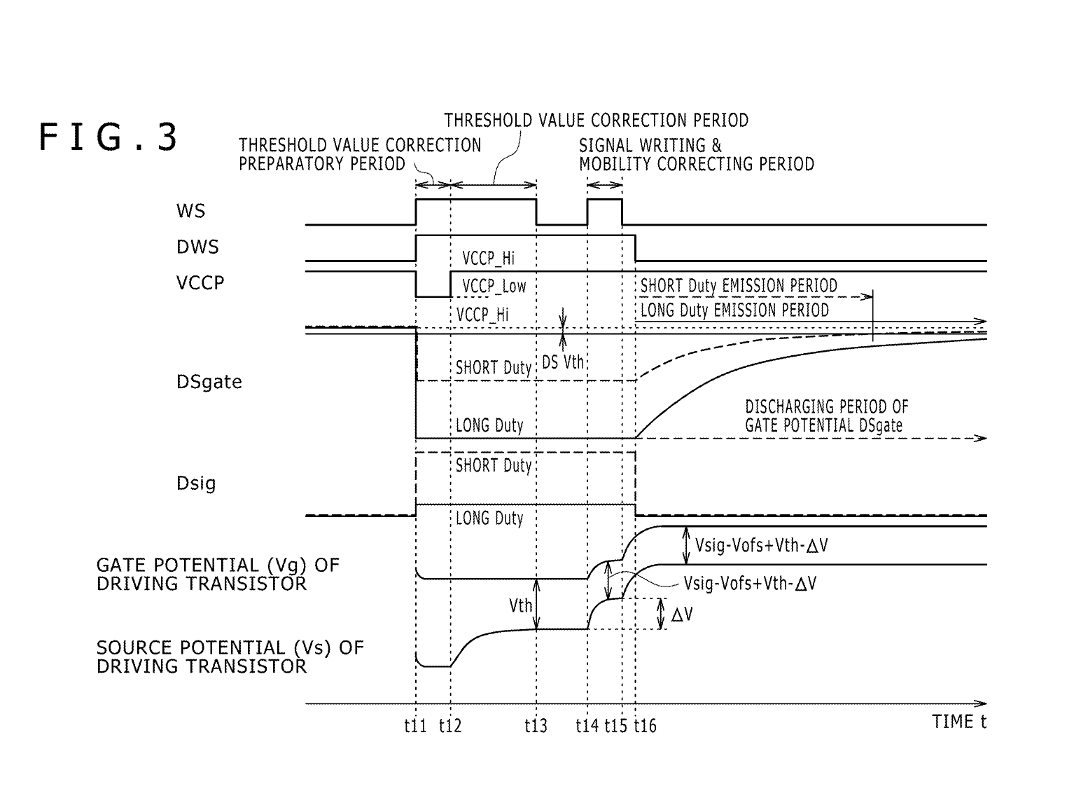

A circuit operation of the organic EL display device 10A according to the first embodiment of the above-described configuration will next be described with reference to a timing waveform chart of FIG. 3.

The timing waveform chart of FIG. 3 shows respective changes in the potential WS of the scanning line 31, the potential DWS of the light emission controlling scanning line 33, the potential (power supply potential) VCCP of the power supply line 32, the gate potential DSgate of the light emission controlling transistor 24, and the potential Dsig of the light emission controlling signal line 35. The timing waveform chart of FIG. 3 further shows changes in the gate potential Vg and the source potential Vs of the driving transistor 22.

### Threshold Value Correction Preparatory Period

In the timing waveform chart of FIG. 3, the potential (writing scanning signal) WS of the scanning line 31 makes a transition from a low potential side to a high potential side at time t11 at which a new frame (present frame) of line-sequential scanning begins. At this time, the potential VCCP of the power supply line 32 changes from the first power supply potential (which will hereinafter be described as a “high potential”) VCCP_Hi to a second power supply potential (which will hereinafter be described as a “low potential”) VCCP_Low sufficiently lower than Vofs−Vth with respect to the reference potential Vofs.

Let Vthel be the threshold voltage of the organic EL element 21, and Vcath be the potential (cathode potential) of the common power supply line 36. At this time, when the low potential VCCP_Low is VCCP_Low<Vthel+Vcath, the source potential Vs of the driving transistor 22 becomes substantially equal to the low potential VCCP_Low, and the organic EL element 21 is set in a reverse-biased state. The organic EL element 21 is therefore set in a quenched state (non-emitting state).

Because the potential WS of the scanning line 31 makes a transition to a high potential, the writing transistor 23 for the video signal is set in a conducting state. At this time, the reference potential Vofs is supplied from the signal outputting circuit 70 to the video signal line 34, so that the gate potential Vg of the driving transistor 22 becomes the reference potential Vofs. The source potential Vs of the driving transistor 22 is the potential VCCP_Low sufficiently lower than the reference potential Vofs.

The gate-to-source voltage Vgs of the driving transistor 22 at this time is Vofs−VCCP_Low. A threshold value correcting process to be described later cannot be performed unless Vofs−VCCP_Low is larger than the threshold voltage Vth of the driving transistor 22. Therefore a potential relation needs to be set such that Vofs−VCCP_Low>Vth.

A process of thus initializing the gate potential Vg and the source potential Vs of the driving transistor 22 by fixing (determining) the gate potential Vg of the driving transistor 22 to the reference potential Vofs and fixing (determining) the source potential Vs of the driving transistor 22 to the low potential VCCP_Low is a process for preparation (threshold value correction preparation) before a threshold value correcting process to be described later is performed. Thus, the reference potential Vofs and the low potential VCCP_Low are the respective initialized potentials of the gate potential Vg and the source potential Vs of the driving transistor 22.

In addition, at time t11, the potential (light emission controlling scanning signal) DWS of the light emission controlling scanning line 33 makes a transition from a low potential side to a high potential side, whereby the writing transistor 25 for the light emission controlling signal is set in a conducting state. Thereby, the light emission period controlling signal Dsig supplied from the light emission period controlling circuit 80 through the light emission controlling signal line 35 is written into the pixel 20A. The light emission controlling transistor 24 is set in a conducting state by writing the light emission period controlling signal Dsig. The light emission period controlling signal Dsig written into the pixel 20A is retained by the storage capacitor 27.

### Threshold Value Correcting Period

Next, when the potential DS of the power supply line 32 changes from the low potential VCCP_Low to the high potential VCCP_Hi at time t12, a threshold value correcting process is started in a state of the gate potential Vg of the driving transistor 22 being retained. Specifically, the source potential Vs of the driving transistor 22 starts rising toward a potential obtained by subtracting the threshold voltage Vth of the driving transistor 22 from the gate potential Vg.

In this case, for convenience, a process of changing the source potential Vs toward the potential obtained by subtracting the threshold voltage Vth of the driving transistor 22 from the initialized potential Vofs with the initialized potential Vofs of the gate electrode of the driving transistor 22 as a reference is referred to as a threshold value correcting process. As the threshold value correcting process progresses, the gate-to-source voltage Vgs of the driving transistor 22 eventually converges to the threshold voltage Vth of the driving transistor 22. A voltage corresponding to the threshold voltage Vth is retained by the storage capacitor 26.

Incidentally, suppose that in this threshold value correcting period (period in which the threshold value correcting process is performed), in order for a current to flow only to the side of the storage capacitor 26 and not to flow to the side of the organic EL element 21, the potential Vcath of the common power supply line 36 is set such that the organic EL element 21 is in a cutoff state.

Next, the potential WS of the scanning line 31 makes a transition to the low potential side at time t13, whereby the writing transistor 23 for the video signal is set in a non-conducting state. At this time, the gate electrode of the driving transistor 22 is electrically disconnected from the signal line 34, and is thereby set in a floating state. However, because the gate-to-source voltage Vgs is equal to the threshold voltage Vth of the driving transistor 22, the driving transistor 22 is in a cutoff state. Therefore, a drain-to-source current Ids does not flow through the driving transistor 22 even when the light emission controlling transistor 24 is in a conducting state.

### Signal Writing and Mobility Correcting Period

Next, the potential WS of the scanning line 31 makes a transition to the high potential side at time t14, whereby the writing transistor 23 for the video signal is set in a conducting state. Incidentally, the potential of the signal line 34 is changed from the reference potential Vofs to the signal voltage Vsig of the video signal before time t14. Thereby, the writing transistor 23 for the video signal samples the signal voltage Vsig of the video signal, and writes the signal voltage Vsig of the video signal into the pixel 20A.

By writing the signal voltage Vsig by the writing transistor 23 for the video signal, the gate potential Vg of the driving transistor 22 becomes the signal voltage Vsig. Then, in driving the driving transistor 22 by the signal voltage Vsig of the video signal, the threshold voltage Vth of the driving transistor 22 is cancelled out by the voltage corresponding to the threshold voltage Vth which voltage is retained in the storage capacitor 26 in the threshold value correcting period. Details of principles of this threshold value cancellation will be described later.

At this time, the organic EL element 21 is in a cutoff state (high-impedance state). Thus, the current (drain-to-source current Ids) flowing from the power supply line 32 through the light emission controlling transistor 24 to the driving transistor 22 according to the signal voltage Vsig of the video signal flows into the equivalent capacitance of the organic EL element 21, and the charging of the equivalent capacitance is started.

The charging of the equivalent capacitance of the organic EL element 21 raises the source potential Vs of the driving transistor 22 with the passage of time. At this time, the threshold voltage Vth of the driving transistor 22 in each pixel is already cancelled, and the drain-to-source current Ids of the driving transistor 22 is dependent on the mobility μ of the driving transistor 22.

Suppose that in this case, a ratio of the retained voltage Vgs retained by the storage capacitor 26 to the signal voltage Vsig of the video signal, that is, a writing gain G is one (ideal value). Then, the source potential Vs of the driving transistor 22 rises to a potential Vofs−Vth+ΔV, whereby the gate-to-source voltage Vgs of the driving transistor 22 is Vsig−Vofs+Vth−ΔV.

That is, the rise ΔV in the source potential Vs of the driving transistor 22 is subtracted from the voltage (Vsig−Vofs+Vth) retained by the storage capacitor 26, or in other words, the rise ΔV in the source potential Vs of the driving transistor 22 acts to discharge the charge stored in the storage capacitor 26, so that a negative feedback is applied. Thus, the rise ΔV in the source potential Vs of the driving transistor 22 is a feedback amount of the negative feedback.

Thus applying a negative feedback to the gate-to-source voltage Vgs by the feedback amount ΔV corresponding to the drain-to-source current Ids flowing through the driving transistor 22 can cancel out the dependence of the drain-to-source current Ids of the driving transistor 22 on the mobility μ. This canceling process is a mobility correcting process that corrects a variation in the mobility μ of the driving transistor 22 in each pixel.

More specifically, the higher the signal amplitude Vin (=Vsig−Vofs) of the video signal written to the gate electrode of the driving transistor 22, the larger the drain-to-source current Ids, and thus the greater the absolute value of the feedback amount ΔV of the negative feedback. Therefore the mobility correcting process is performed according to light emission luminance level.

In addition, when the signal amplitude Vin of the video signal is fixed, the higher the mobility μ of the driving transistor 22, the greater the absolute value of the feedback amount ΔV of the negative feedback, so that a variation in mobility μ in each pixel can be eliminated. Therefore the feedback amount ΔV of the negative feedback can also be said to be a correction amount of mobility correction. Details of principles of the mobility correction will be described later.

### Emission Period

Next, the potential WS of the scanning line 31 makes a transition to the low potential side at time t15, whereby the writing transistor 23 for the video signal is set in a non-conducting state. Thereby, the gate electrode of the driving transistor 22 is electrically disconnected from the video signal line 34, and is thus set in a floating state.

When the gate electrode of the driving transistor 22 is in a floating state, the gate potential Vg of the driving transistor 22 varies in such a manner as to be interlocked with variation in the source potential Vs of the driving transistor 22 because the storage capacitor 26 is connected between the gate and the source of the driving transistor 22. The operation of the gate potential Vg of the driving transistor 22 thus varying in such a manner as to be interlocked with variation in the source potential Vs of the driving transistor 22 is a bootstrap operation by the storage capacitor 26.

The gate electrode of the driving transistor 22 is set in a floating state, and at the same time, the drain-to-source current Ids of the driving transistor 22 starts to flow to the organic EL element 21. Thereby the anode potential of the organic EL element 21 rises according to the current Ids.

When the anode potential of the organic EL element 21 exceeds Vthel+Vcath, the driving current starts flowing through the organic EL element 21, and therefore the organic EL element 21 starts emitting light. A rise in the anode potential of the organic EL element 21 is none other than a rise in the source potential Vs of the driving transistor 22. When the source potential Vs of the driving transistor 22 rises, the gate potential Vg of the driving transistor 22 is also raised in an interlocked manner by the bootstrap operation of the storage capacitor 26.

At this time, supposing that a bootstrap gain is one (ideal value), the amount of the rise in the gate potential Vg is equal to the amount of the rise in the source potential Vs. Therefore the gate-to-source voltage Vgs of the driving transistor 22 during the emission period is maintained at a fixed level Vsig−Vofs+Vth−ΔV.

### Control of Emission Period

Next, the potential DWS of the light emission controlling scanning line 33 makes a transition from the high potential side to the low potential side at time t16, whereby the writing transistor 25 for the light emission controlling signal is set in a non-conducting state. Then, the charge retained by the storage capacitor 27 and corresponding to the signal voltage Dsig of the light emission period controlling signal is discharged through the discharging path including the resistive element 28 with the time constant determined by the capacitance value of the storage capacitor 27 and the resistance value of the resistive element 28.

Incidentally, during the conduction period (t11 to t16) of the writing transistor 25 for the light emission controlling signal, the signal voltage Dsig of the light emission period controlling signal continues being written. Thus, even when the discharging path formed by the resistive element 28 is present, the gate potential DSgate of the light emission controlling transistor 24 remains the signal voltage Dsig. When the signal voltage Dsig of the light emission period controlling signal is set individually, the gate potential DSgate of the light emission controlling transistor 24 in each pixel 20A can be determined individually.

Discharging the charge of the storage capacitor 27 varies the gate potential DSgate of the light emission controlling transistor 24 at the varying speed determined by the discharging time constant and the signal voltage Dsig of the light emission period controlling signal. At this time, when the gate potential DSgate of the light emission controlling transistor 24 becomes equal to VCCP_Hi−DS_Vth, the light emission controlling transistor 24 is set in a non-conducting state. At this time, timing of making a transition from an emitting state to a non-emitting state, that is, the length of an emission period is determined according to the varying speed of the gate potential DSgate of the light emission controlling transistor 24.

Specifically, as shown in FIG. 3, a period taken for the gate potential DSgate to reach the high potential VCCP_Hi after EL light emission changes according to difference in the gate potential DSgate of the light emission controlling transistor 24 which potential is determined by the signal voltage Dsig of the light emission period controlling signal. That is, the emission period can be determined individually by the signal voltage Dsig of the light emission period controlling signal written at the time of a start of the light emission. Thus, by individually setting the signal voltage Dsig of the light emission period controlling signal written to the pixel 20A pixel by pixel, the emission period of the organic EL element 21 can be controlled in each pixel 20A rather than being controlled uniformly over the entire screen.

The respective process operations of the threshold value correction preparation, the threshold value correction, the writing of the signal voltage Vsig (signal writing), and the mobility correction in the series of circuit operations described above are performed in one horizontal scanning period (1 H). The respective process operations of the signal writing and the mobility correction are performed in parallel with each other in a period from time t14 to t15 during which the writing scanning signal WS is in an active state.

Incidentally, while the above description has been made by taking as an example a driving method that performs the threshold value correcting process only once, this driving method is a mere example, and the present invention is not limited to this driving method. For example, a driving method can be adopted which performs a so-called divided threshold value correction, in which the threshold value correcting process is divided and performed a plurality of times in not only the 1-H period in which the threshold value correcting process is performed together with the mobility correcting and signal writing process but also a plurality of horizontal scanning periods preceding the 1-H period.

By thus adopting the driving method of the divided threshold value correction, a sufficient time can be secured as a threshold value correcting period over a plurality of horizontal scanning periods even when a time assigned to one horizontal scanning period is shortened due to an increase in the number of pixels which increase is involved in achieving higher definition. Therefore the threshold value correcting process can be performed surely.

### Principles of Threshold Value Cancellation

Principles of threshold value cancellation (that is, threshold value correction) of the driving transistor 22 will be described in the following. The driving transistor 22 is designed to operate in a saturation region, and thus operates as a constant-current source. Thereby a constant drain-to-source current (driving current) Ids given by the following Equation (1) is supplied from the driving transistor 22 to the organic EL element 21.

Ids=(1/2)·μ(W/L)Cox(Vgs−Vth)² (1)

where W is the channel width of the driving transistor 22, L is the channel length of the driving transistor 22, and Cox is gate capacitance per unit area.

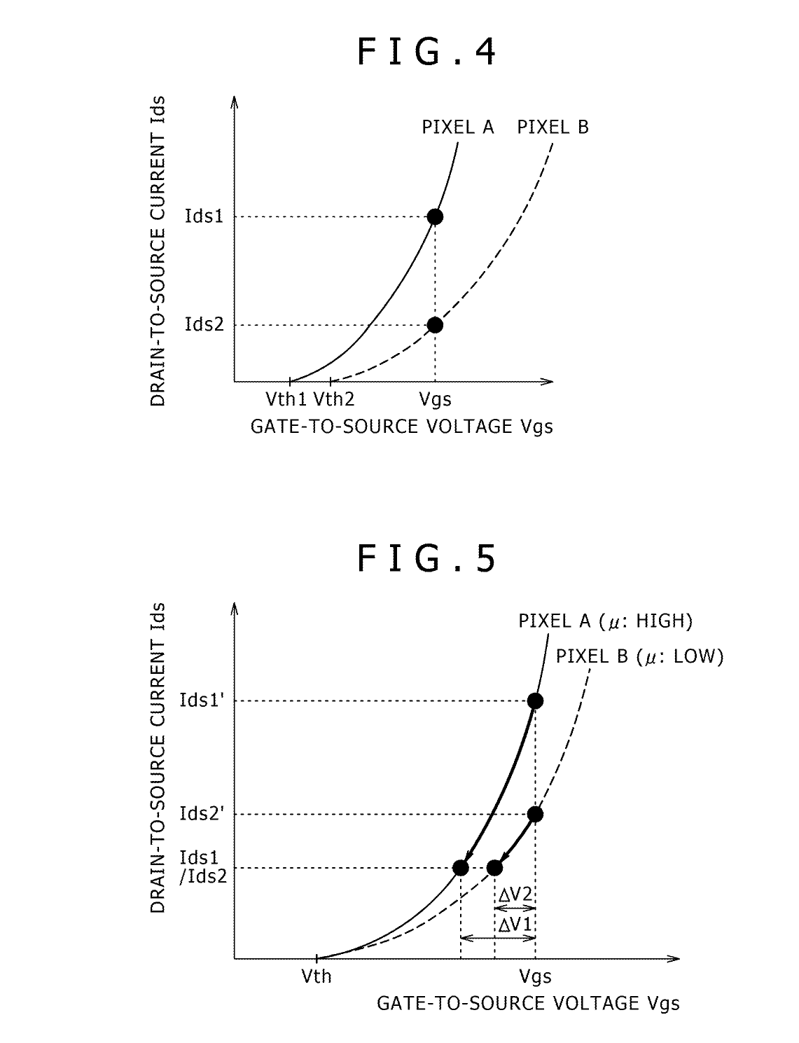

FIG. 4 shows a characteristic of the drain-to-source current Ids of the driving transistor 22 versus the gate-to-source voltage Vgs of the driving transistor 22.

As shown in this characteristic diagram, in a case where variation in the threshold voltage Vth of the driving transistor 22 in each pixel is not cancelled, when the threshold voltage Vth is Vth1, the drain-to-source current Ids corresponding to the gate-to-source voltage Vgs is Ids1.

On the other hand, when the threshold voltage Vth is Vth2 (Vth2>Vth1), the drain-to-source current Ids corresponding to the same gate-to-source voltage Vgs is Ids2 (Ids2<Ids1). That is, when the threshold voltage Vth of the driving transistor 22 varies, the drain-to-source current Ids varies even if the gate-to-source voltage Vgs is constant.

On the other hand, in the pixel (pixel circuit) 20A of the above-described configuration, the gate-to-source voltage Vgs of the driving transistor 22 at the time of light emission is Vsig−Vofs+Vth−ΔV, as described above. Thus, when this is substituted into Equation (1), the drain-to-source current Ids is expressed by the following Equation (2).

Ids=(1/2)·μ(W/L)Cox(Vsig−Vofs−ΔV)² (2)

That is, the term of the threshold voltage Vth of the driving transistor 22 is cancelled, and therefore the drain-to-source current Ids supplied from the driving transistor 22 to the organic EL element 21 is not dependent on the threshold voltage Vth of the driving transistor 22. As a result, even when the threshold voltage Vth of the driving transistor 22 varies in each pixel due to variations in a process of manufacturing the driving transistor 22 or a secular change in the driving transistor 22, the drain-to-source current Ids does not vary. Therefore the light emission luminance of the organic EL element 21 can be held constant.

### Principles of Mobility Correction

Principles of the mobility correction of the driving transistor 22 will next be described. FIG. 5 shows characteristic curves in a state in which a pixel A whose driving transistor 22 has a relatively high mobility μ and a pixel B whose driving transistor 22 has a relatively low mobility μ are compared with each other. When the driving transistor 22 is formed by a polysilicon thin film transistor or the like, the mobility μ inevitably varies between pixels such as the pixel A and the pixel B.

Consideration will be given to a case where a signal amplitude Vin (=Vsig−Vofs) at a same level for both pixels A and B is written to the gate electrodes of the driving transistors 22 with the mobility μ varying between the pixel A and the pixel B. In this case, when no correction is made for the mobility μ, a large difference occurs between a drain-to-source current Ids1′ flowing in the pixel A of high mobility μ and a drain-to-source current Ids2′ flowing in the pixel B of low mobility μ. A large difference in drain-to-source current Ids thus occurring between pixels due to a variation in mobility μ in each pixel impairs the uniformity of the screen.

As is clear from the above-described Equation (1) as a transistor characteristic equation, when the mobility μ is high, the drain-to-source current Ids is increased. Hence, the higher the mobility μ, the larger the feedback amount ΔV of negative feedback. As shown in FIG. 5, the feedback amount ΔV1 of the pixel A of high mobility μ is larger than the feedback amount ΔV2 of the pixel B of low mobility.

Accordingly, the mobility correcting process applies a negative feedback to the gate-to-source voltage Vgs by a feedback amount ΔV corresponding to the drain-to-source current Ids of the driving transistor 22. Thereby, the higher the mobility μ, the larger the amount of negative feedback. As a result, variations in mobility μ in each pixel can be suppressed.

Specifically, when the correction of the feedback amount ΔV1 is applied in the pixel A of high mobility μ, the drain-to-source current Ids falls greatly from Ids1′ to Ids1. On the other hand, because the feedback amount ΔV2 of the pixel B of low mobility μ is small, the drain-to-source current Ids falls from Ids2′ to Ids2, and thus does not fall so greatly. Consequently, the drain-to-source current Ids1 of the pixel A and the drain-to-source current Ids2 of the pixel B become substantially equal to each other. Therefore variations in mobility μ in each pixel are corrected.

Summarizing the above, when there are a pixel A and a pixel B of different mobilities p, the feedback amount ΔV1 of the pixel A of high mobility μ is larger than the feedback amount ΔV2 of the pixel B of low mobility μ. That is, the higher the mobility μ of a pixel, the larger the feedback amount ΔV, and the larger the amount of decrease in drain-to-source current Ids.

Thus, by applying a negative feedback to the gate-to-source voltage Vgs by a feedback amount ΔV corresponding to the drain-to-source current Ids of the driving transistor 22, the current values of drain-to-source currents Ids in pixels of different mobilities μ are uniformized. As a result, variations in mobility μ in each pixel can be corrected. That is, the process of applying a negative feedback to the gate-to-source voltage Vgs of the driving transistor 22 by a feedback amount ΔV corresponding to the current (drain-to-source current Ids) flowing through the driving transistor 22 is the mobility correcting process.

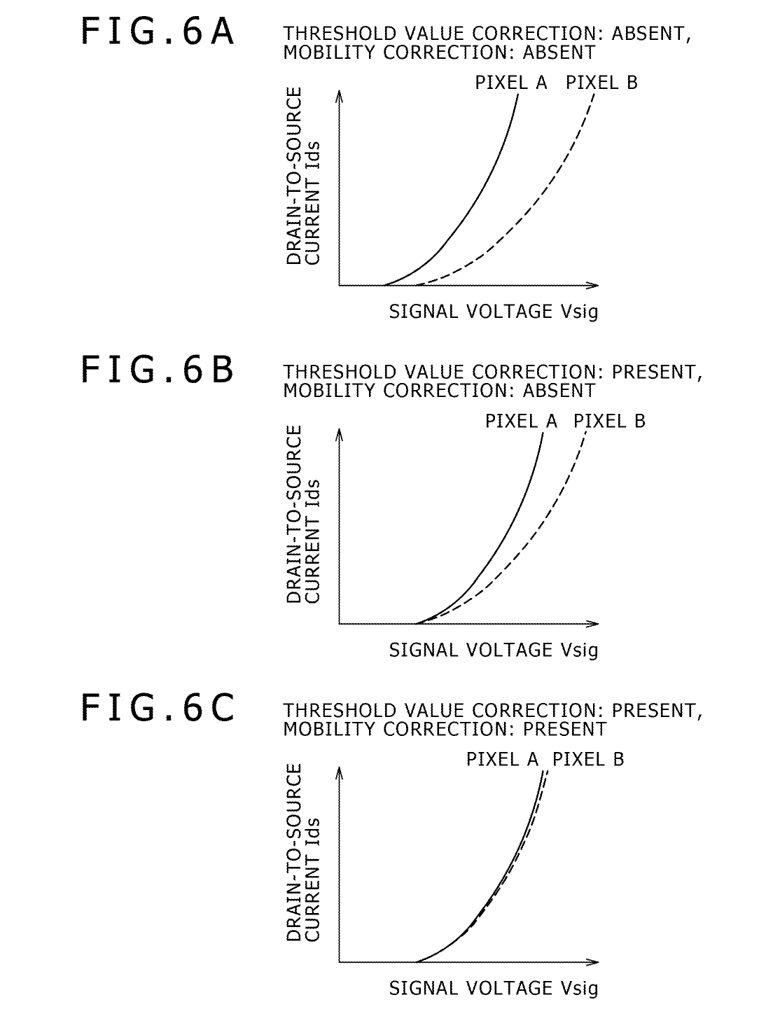

Relations between the signal voltage Vsig of the video signal and the drain-to-source current Ids of the driving transistor 22 according to whether threshold value correction and mobility correction are performed or not in the pixel (pixel circuit) 20A shown in FIG. 2 will be described with reference to FIGS. 6A, 6B, and 6C.

FIG. 6A represents a case where neither threshold value correction nor mobility correction is performed; FIG. 6B represents a case where mobility correction is not performed and only threshold value correction is performed; and FIG. 6C represents a case where threshold value correction and mobility correction are both performed. As shown in FIG. 6A, when neither threshold value correction nor mobility correction is performed, variations in threshold voltage Vth and mobility μ in the pixels A and B cause a large difference in drain-to-source current Ids between the pixels A and B.

On the other hand, when only threshold value correction is performed, as shown in FIG. 6B, variations in drain-to-source current Ids can be reduced to some extent, but a difference in drain-to-source current Ids between the pixels A and B due to variations in mobility μ in the pixels A and B remains. By performing both threshold value correction and mobility correction, as shown in FIG. 6C, a difference in drain-to-source current Ids between the pixels A and B due to variations in threshold voltage Vth and mobility μ in the pixels A and B can be substantially eliminated. Thus, no variations in luminance of the organic EL element 21 occur at any gradation, so that a display image of excellent image quality can be obtained.

In addition, the pixel 20A shown in FIG. 2 can provide the following action and effect by having the function of bootstrap operation by the storage capacitor 26 as described above in addition to the respective correcting functions of threshold value correction and mobility correction.

Even when the source potential Vs of the driving transistor 22 is changed with secular change in the I-V characteristic of the organic EL element 21, the gate-to-source voltage Vgs of the driving transistor 22 can be held constant by the bootstrap operation of the storage capacitor 26. Therefore the current flowing through the organic EL element 21 is unchanged and constant. As a result, the light emission luminance of the organic EL element 21 is also held constant. Thus, even when a secular change in I-V characteristic of the organic EL element 21 occurs, image display without luminance degradation attendant on the secular change in I-V characteristic of the organic EL element 21 can be achieved.

In particular, the organic EL display device 10A according to the present embodiment can control the emission period of the organic EL element 21 in each pixel 20A by the signal voltage Dsig of the light emission period controlling signal controlling the gate potential DSgate of the light emission controlling transistor 24. Thus, novel image control is enabled which image control cannot be expected of a configuration that controls the emission period uniformly over the entire screen. The novel image control includes for example image control that sets the emission period of only one pixel long and which thereby makes the light emission luminance of the pixel extremely high as compared with other pixels and image control where image processing is performed such that flicker differs within the screen according to the video of a movie or the like.

### 1-3. Example of Modification

### First Example of Modification

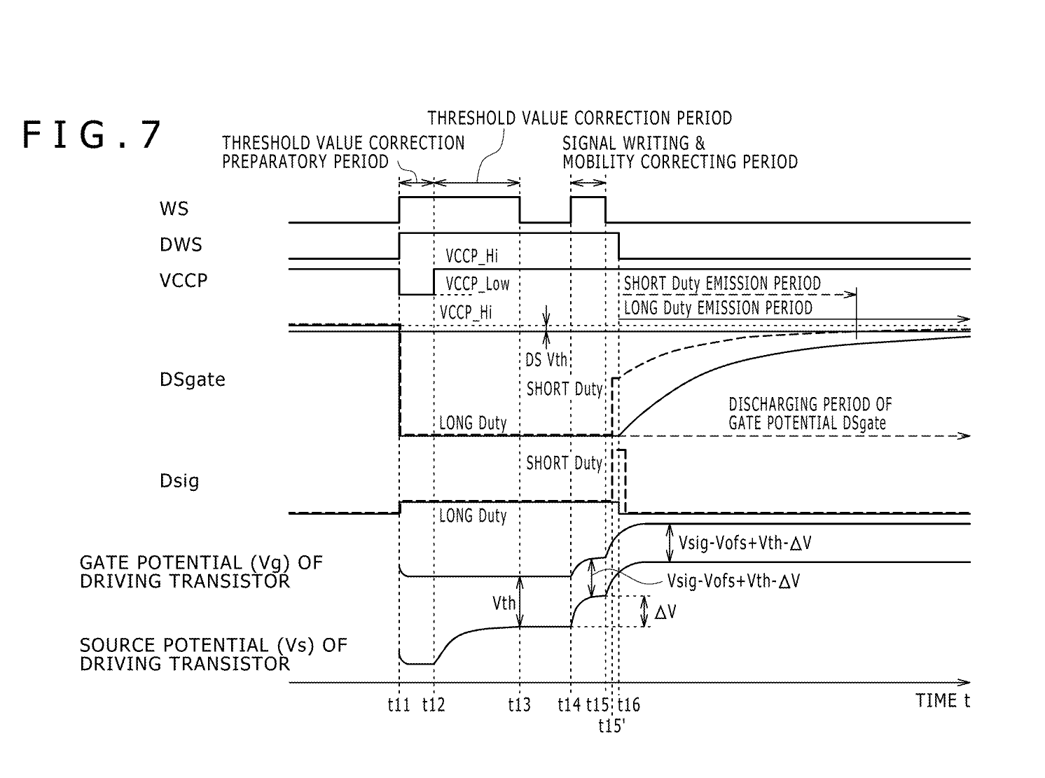

The foregoing embodiment employs a configuration that writes the signal voltage Dsig of the light emission period controlling signal determining the emission period of each pixel over the conduction period (t11 to t16) of the writing transistor 25 for the light emission controlling signal. On the other hand, as shown in the timing waveform chart of FIG. 7, the present example of modification writes a fixed signal voltage, for example a signal voltage for setting the emission period to a maximum irrespective of the emission period of each pixel from time t11 to an end of the mobility correcting period.

Then, the signal voltage Dsig of the light emission period controlling signal determining the emission period of each pixel is written in a conduction period (t15′ to t16) of the writing transistor 25 for the light emission controlling signal after the end of the mobility correcting period. Such driving control can be achieved by making the signal voltage output from the light emission period controlling circuit 80 to the light emission controlling signal line 35 fixed irrespective of the emission period of each pixel before time t15′ and changing the signal voltage to the signal voltage Dsig determining the emission period of each pixel at time t15′.

When the signal voltage Dsig determining the emission period of each pixel is written before the mobility correcting process is performed as in the foregoing embodiment, the signal voltage Dsig may change the resistive component of the light emission controlling transistor 24 in each pixel. Then, the current flowing through the driving transistor 22 varies in each pixel, and thus variation occurs in mobility correction in each pixel. This means that mobility correction cannot be made normally for each pixel.

On the other hand, by writing a fixed signal voltage irrespective of the emission period of each pixel before the mobility correcting process is performed, the change in resistive component of the light emission controlling transistor 24 in each pixel can be suppressed, and therefore mobility correction can be made normally for each pixel. In addition, the emission period of each pixel can be controlled normally by the signal voltage Dsig of the light emission period controlling signal determining the emission period of each pixel, the signal voltage Dsig of the light emission period controlling signal being written after the mobility correcting process.

### Second Example of Modification

While a P-channel type transistor is used as the light emission controlling transistor 24 in the foregoing embodiment, an N-channel type transistor can be used as the light emission controlling transistor 24. This will be described below as a second example of modification.

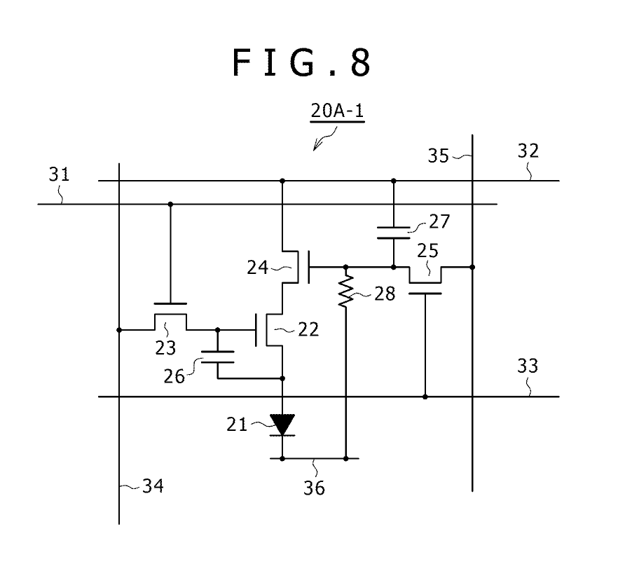

FIG. 8 is a circuit diagram showing a pixel circuit of an organic EL display device according to the second example of modification. As shown in FIG. 8, a pixel 20A-1 according to the second example of modification is of a circuit configuration using an N-channel type TFT as a light emission controlling transistor 24. Correspondingly, a resistive element 28 forming a discharging path has one end connected to the gate electrode of the light emission controlling transistor 24, and has another end connected to a common power supply line 36 supplying a cathode potential Vcath. While a point of connection to which the other end of the resistive element 28 is connected is the common power supply line 36 in this case, it suffices for the point of connection to which the other end of the resistive element 28 is connected to be the node of a potential capable of cutting off the light emission controlling transistor 24, and the point of connection to which the other end of the resistive element 28 is connected is not limited to the common power supply line 36.

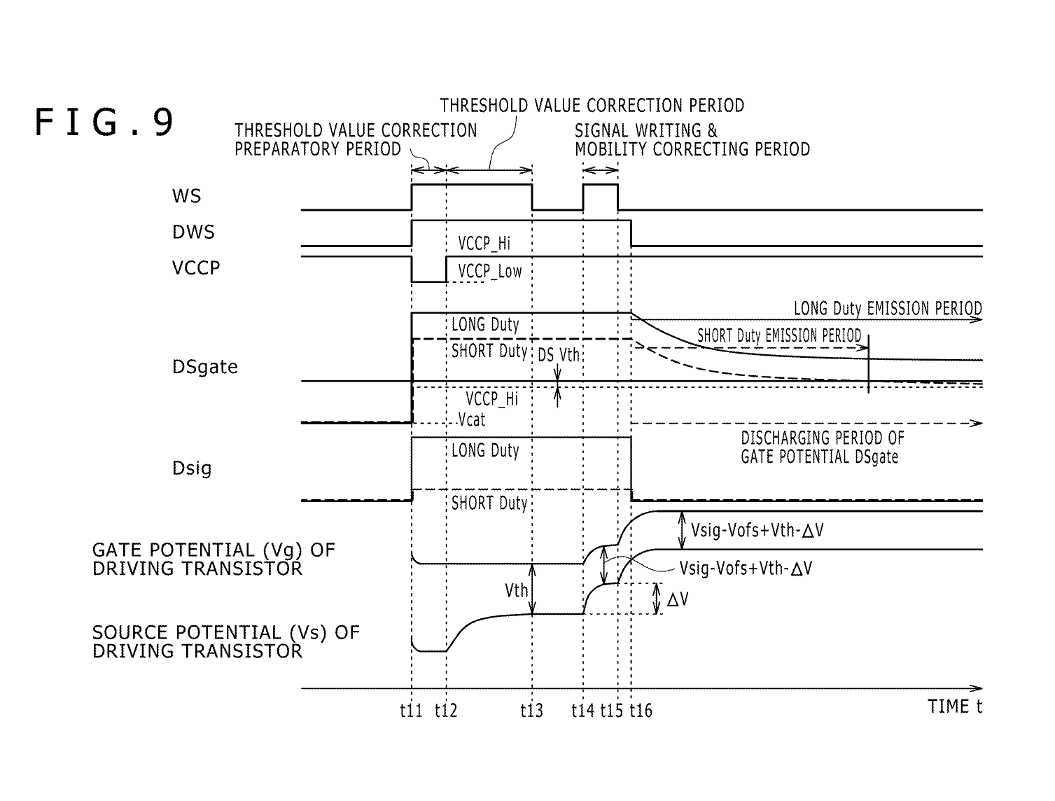

FIG. 9 is a timing waveform chart of assistance in explaining a circuit operation of the organic EL display device according to the second example of modification. In FIG. 9, the same parts as in FIG. 3 (corresponding parts) are identified by the same reference symbols. The circuit operation of the organic EL display device according to the second example of modification is basically the same as in the foregoing embodiment, and is different only in polarity of the gate potential DSgate of the light emission controlling transistor 24, as is clear from a comparison between FIG. 9 and FIG. 3. Thus, the organic EL display device according to the second example of modification can also provide the same action and effect as the organic EL display device according to the foregoing embodiment.

### Third Example of Modification

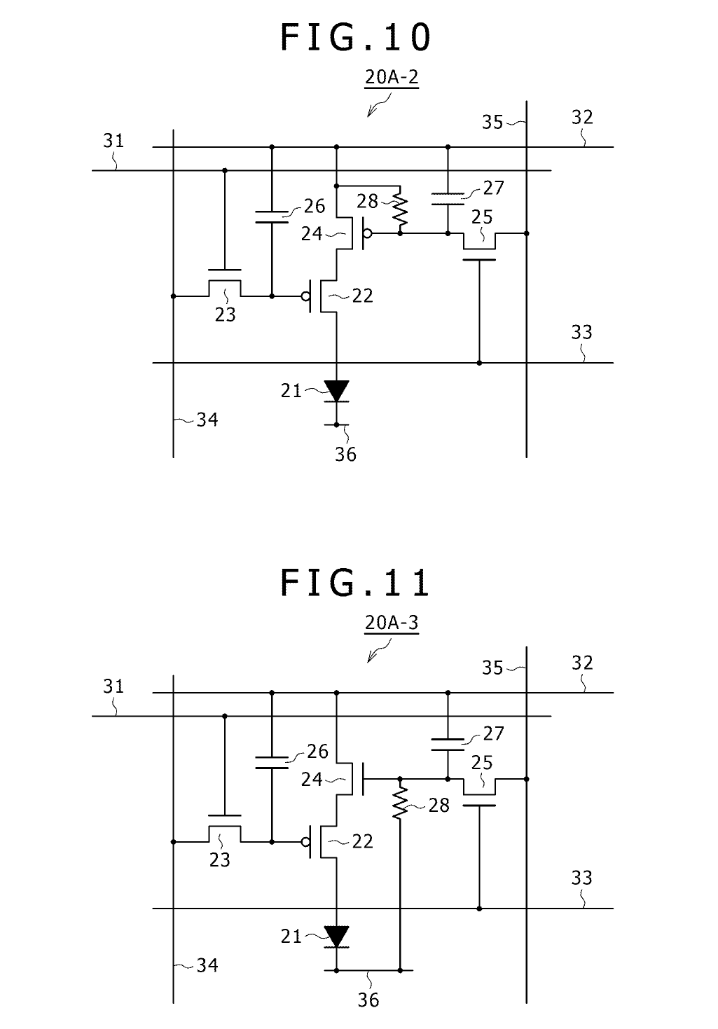

FIG. 10 is a circuit diagram showing a pixel circuit of an organic EL display device according to a third example of modification. As shown in FIG. 10, a pixel 20A-2 according to the third example of modification is of a circuit configuration using a P-channel type TFT both as a driving transistor 22 and as a light emission controlling transistor 24. Correspondingly, one electrode of a storage capacitor 26 is connected to the gate electrode of the driving transistor 22, and another electrode of the storage capacitor 26 is connected to a power supply line 32. The organic EL display device according to the third example of modification can also provide the same action and effect as the organic EL display device according to the foregoing embodiment.

### Fourth Example of Modification

FIG. 11 is a circuit diagram showing a pixel circuit of an organic EL display device according to a fourth example of modification. As shown in FIG. 11, a pixel 20A-3 according to the fourth example of modification is of a circuit configuration using a P-channel type TFT as a driving transistor 22 and using an N-channel type TFT as a light emission controlling transistor 24.

Correspondingly, one electrode of a storage capacitor 26 is connected to the gate electrode of the driving transistor 22, and another electrode of the storage capacitor 26 is connected to a power supply line 32. A storage capacitor 27 has one electrode connected to the gate electrode of the light emission controlling transistor 24, and has another electrode connected to the power supply line 32. The organic EL display device according to the fourth example of modification can also provide the same action and effect as the organic EL display device according to the foregoing embodiment.

### 2. Second Embodiment

### 2-1. System Configuration

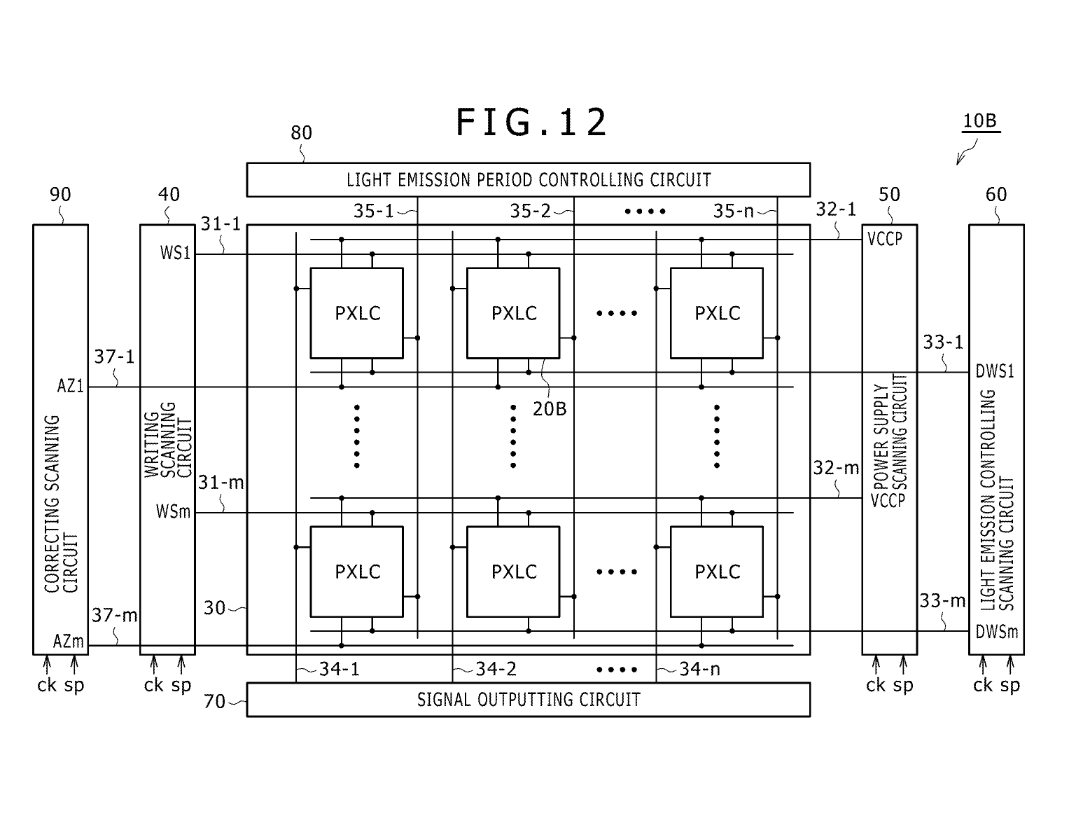

FIG. 12 is a system configuration diagram showing an outline of configuration of an active matrix type display device according to a second embodiment of the present invention. In FIG. 12, the same parts as in FIG. 1 (corresponding parts) are identified by the same reference numerals, and repeated description thereof will be omitted.

Also in the present embodiment, description will be made by taking as an example a case of an active matrix type organic EL display device using a current-driven type electrooptic element changing in light emission luminance according to the value of a current flowing in a device, which electrooptic element is for example an organic EL element, as a light emitting element of a pixel (pixel circuit).

The organic EL display device 10B according to the second embodiment includes a correcting scanning circuit 90 in addition to a writing scanning circuit 40, a power supply scanning circuit 50, a light emission controlling scanning circuit 60, a signal outputting circuit 70, and a light emission period controlling circuit 80 as a driving section on the periphery of a pixel array section 30. However, while the power supply scanning circuit 50 in the first embodiment assumes two values VCCP_Hi and VCCP_Low as power supply potential VCCP, the power supply scanning circuit 50 in the second embodiment assumes a fixed power supply potential VCCP.

In the pixel array section 30, correction controlling scanning lines 37-1 to 37-m in addition to power supply lines 32-1 to 32-m and light emission controlling scanning lines 33-1 to 33-m are arranged in each pixel row in an arrangement of pixels 20B of m rows and n columns. Further, video signal lines 34-1 to 34-n and light emission controlling signal lines 35-1 to 35-n are arranged in each pixel column along a column direction.

The correcting scanning circuit 90 is formed by a shift register or the like that shifts a start pulse sp in order in synchronism with a clock pulse ck. In performing a threshold value correcting process, the correcting scanning circuit 90 outputs a correction controlling scanning signal AZ (AZ1 to AZm) to the correction controlling scanning lines 37-1 to 37-m in synchronism with line-sequential scanning of the writing scanning circuit 40.

### Pixel Circuit

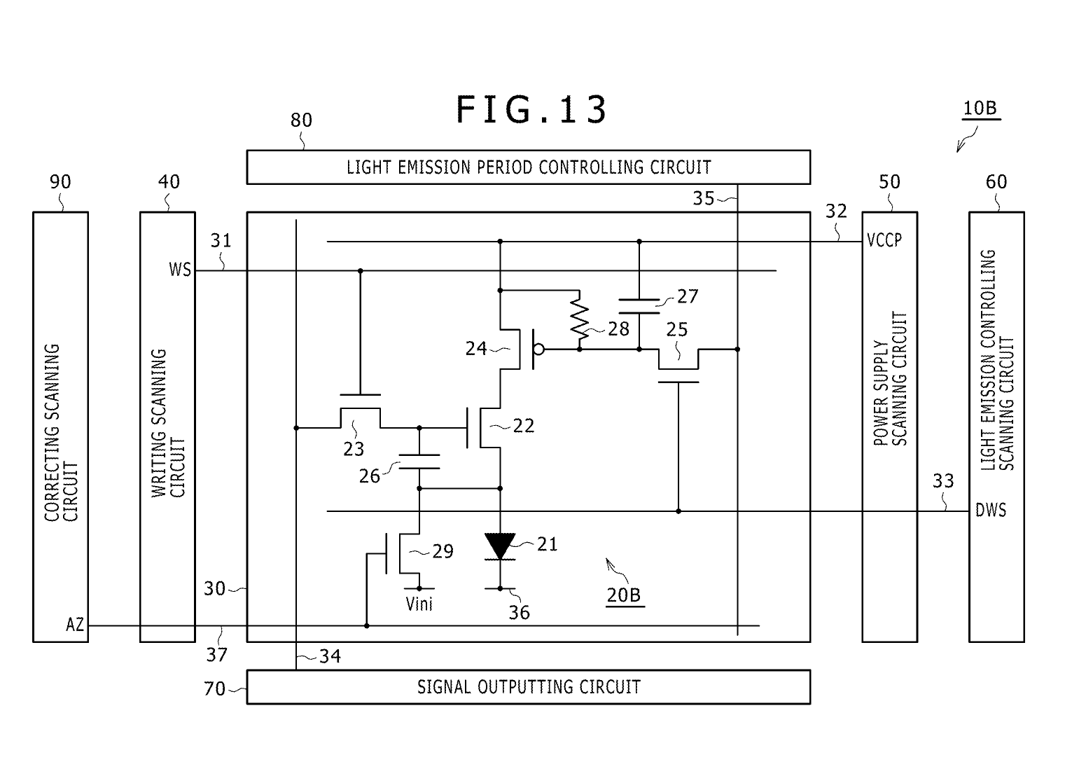

FIG. 13 is a circuit diagram showing a concrete circuit configuration of a pixel (pixel circuit) 20B. In FIG. 13, the same parts as in FIG. 2 are identified by the same reference numerals, and repeated description thereof will be omitted.

As shown in FIG. 13, the pixel 20B includes a switching transistor 29 in addition to a driving transistor 22, a writing transistor 23 for a video signal, a light emission controlling transistor 24, and a writing transistor 25 for a light emission controlling signal as pixel transistors.

In this case, an N-channel TFT is used as the driving transistor 22, the writing transistor 23 for the video signal, the writing transistor 25 for the light emission controlling signal, and the switching transistor 29, and a P-channel TFT is used as the light emission controlling transistor 24. However, the combination of conductivity types of these transistors 22 to 25 and 29 is a mere example, and is not limited to the combination of these conductivity types of the transistors 22 to 25 and 29.

The switching transistor 29 has a drain electrode connected to the anode electrode of an organic EL element 21, another electrode of the driving transistor 22, and another electrode of a storage capacitor 26, and has a source electrode connected to a node of a fixed potential Vini. The fixed potential Vini in this case corresponds to a second power supply potential VCCP_Low in the first embodiment. That is, the fixed potential Vini is a potential for applying a reverse bias to the organic EL element 21. The fixed potential Vini is therefore set lower than a reference potential Vofs, or preferably set sufficiently lower than Vofs—Vth.

The switching transistor 29 is set in a conducting state in response to a high-active correction controlling scanning signal AZ output from the correcting scanning circuit 90 prior to the threshold value correcting process and applied to the gate electrode of the switching transistor 29 through the correction controlling scanning line 37. The switching transistor 29 thereby applies the fixed potential Vini to the source electrode of the driving transistor 22. That is, the fixed potential Vini becomes an initialized potential of a source potential Vs of the driving transistor 22.

### 2-2. Circuit Operation

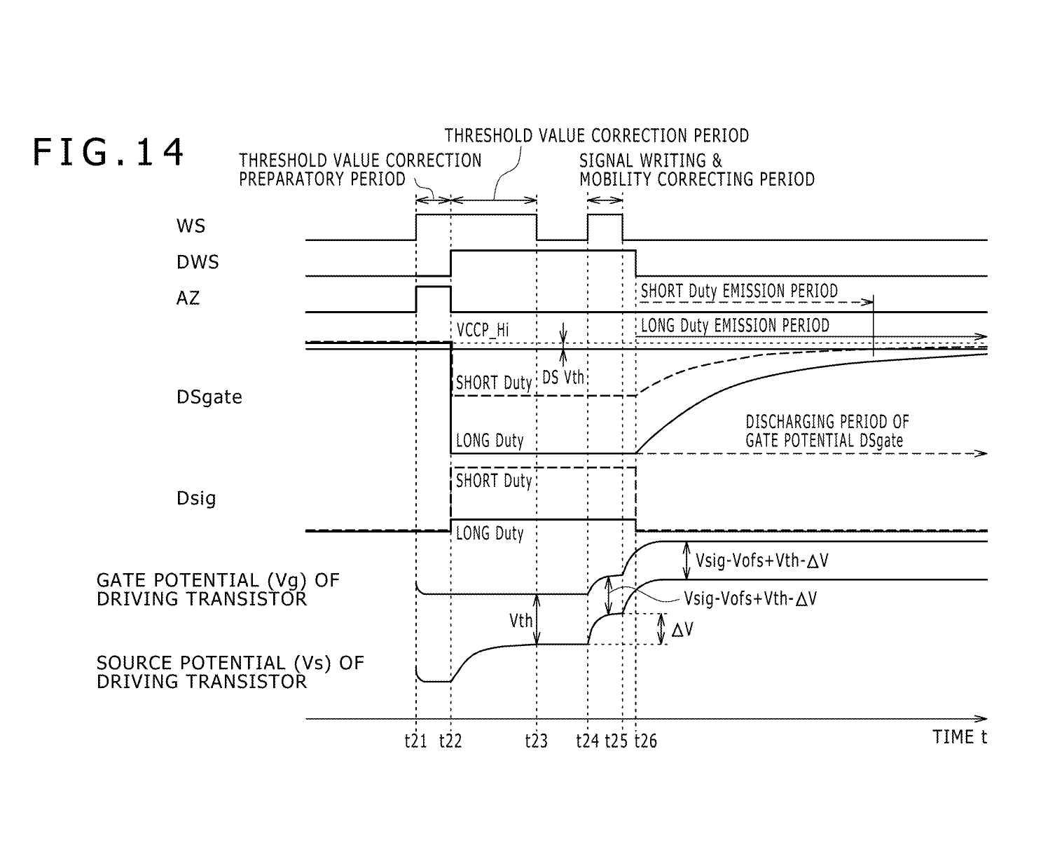

A circuit operation of the organic EL display device 10B according to the second embodiment of the above-described configuration will next be described with reference to a timing waveform chart of FIG. 14.

The timing waveform chart of FIG. 14 shows respective changes in the potential WS of a scanning line 31, the potential DWS of the light emission controlling scanning line 33, the potential AZ of the correction controlling scanning line 37, the gate potential DSgate of the light emission controlling transistor 24, and the potential Dsig of the light emission controlling signal line 35. The timing waveform chart of FIG. 14 further shows changes in the gate potential Vg and the source potential Vs of the driving transistor 22. Incidentally, times t21 to t26 in the timing waveform chart of FIG. 14 correspond to the times t11 to t16 in the timing waveform chart of FIG. 3.

### Threshold Value Correction Preparatory Period

In FIG. 14, the potential WS of the scanning line 31 makes a transition from a low potential side to a high potential side at time t21 at which a new frame (present frame) of line-sequential scanning begins. At this time, the potential (correction controlling scanning signal) AZ of the correction controlling scanning line 37 simultaneously makes a transition from a low potential side to a high potential side. The switching transistor 29 is thereby set in a conducting state to apply the fixed potential Vini to the source electrode of the driving transistor 22. At this time, when the fixed potential Vini is Vini<Vthel+Vcath, the organic EL element 21 is set in a reverse-biased state, and is therefore set in a quenched state.

Because the potential WS of the scanning line 31 makes a transition to a high potential, the writing transistor 23 for the video signal is set in a conducting state. At this time, the reference potential Vofs is supplied from the signal outputting circuit 70 to the video signal line 34, so that the gate potential Vg of the driving transistor 22 becomes the reference potential Vofs. The source potential Vs of the driving transistor 22 is the fixed potential Vini sufficiently lower than the reference potential Vofs.

The gate-to-source voltage Vgs of the driving transistor 22 at this time is Vofs−Vini. A threshold value correcting process cannot be performed unless Vofs−Vini is larger than the threshold voltage Vth of the driving transistor 22. Therefore a potential relation needs to be set such that Vofs−Vini>Vth.

As a result of the above, the gate potential Vg of the driving transistor 22 is initialized to the reference potential Vofs, and the source potential Vs of the driving transistor 22 is initialized to the fixed potential Vini.

Next, at time t22, the potential DWS of the light emission controlling scanning line 33 makes a transition from a low potential side to a high potential side, whereby the writing transistor 25 for the light emission controlling signal is set in a conducting state. Thereby, the light emission period controlling signal Dsig supplied from the light emission period controlling circuit 80 through the light emission controlling signal line 35 is written into the pixel 20B. The light emission controlling transistor 24 is set in a conducting state by writing the light emission period controlling signal Dsig. The light emission period controlling signal Dsig written into the pixel 20B is retained by a storage capacitor 27.

A threshold value correcting process, a signal writing and mobility correcting process, and control of an emission period of each pixel to be thereafter performed in order are similar to those of the first embodiment. Thus, the organic EL display device 10B according to the second embodiment of the configuration that initializes the source potential Vs of the driving transistor 22 by the switching transistor 29 with the power supply potential VCCP fixed can also provide the same action and effect as in the first embodiment.

Specifically, the emission period of the organic EL element 21 can be controlled in each pixel 20B by the signal voltage Dsig of the light emission period controlling signal controlling the gate potential DSgate of the light emission controlling transistor 24. Thus, novel image control is enabled which image control cannot be expected of a configuration that controls the emission period uniformly over the entire screen. As described above, the novel image control includes for example image control that sets the emission period of only one pixel long and which thereby makes the light emission luminance of the pixel extremely high as compared with other pixels and image control where image processing is performed such that flicker differs within the screen according to the video of a movie or the like.

### 2-3. Examples of Modification

The foregoing first to fourth examples of modification are applicable to the organic EL display device 10B according to the second embodiment as well as the organic EL display device 10A according to the first embodiment.

### 3. Examples of Modification

In each of the foregoing embodiments, description has been made by taking as an example a case where the embodiments of the present invention are applied to an organic EL display device using an organic EL element as the electrooptic element of a pixel 20. However, embodiments of the present invention are not limited to this example of application. Specifically, embodiments of the present invention are applicable to display devices in general using a current-driven type electrooptic element (light emitting element) whose light emission luminance changes according to the value of a current flowing through the device, such as an inorganic EL element, an LED (Light Emitting Diode) element, a semiconductor laser element or the like.

### 4. Examples of Application

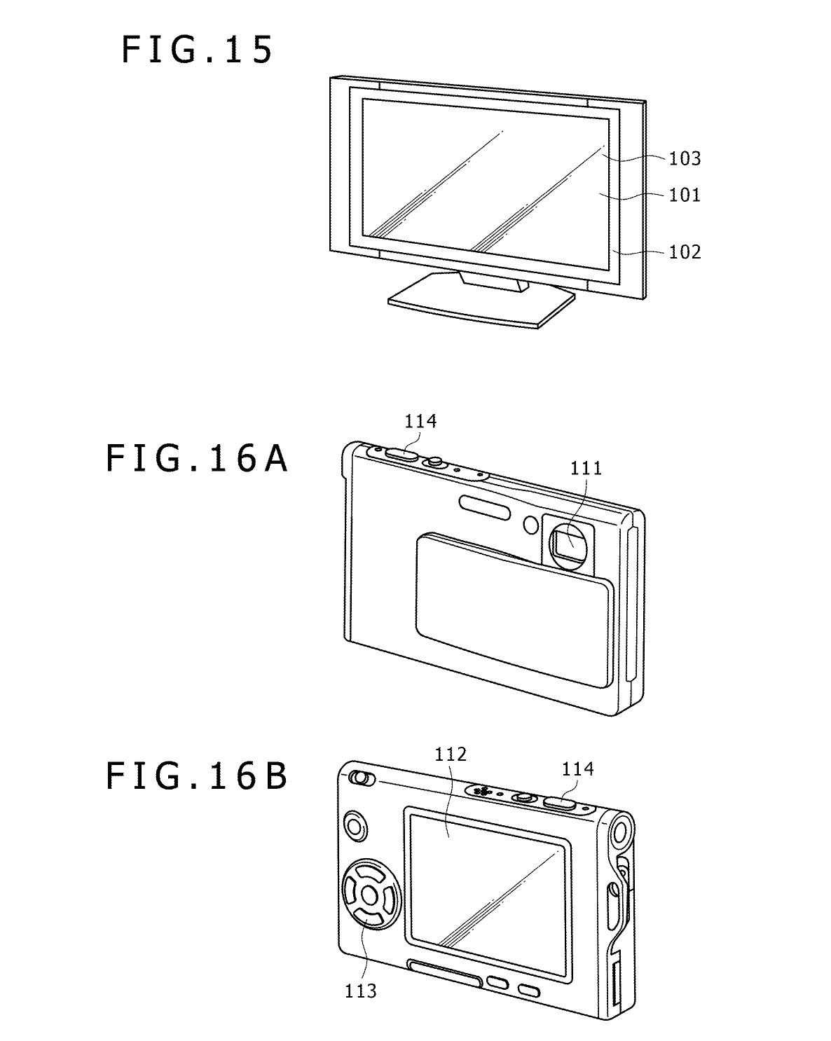

A display device according to an embodiment of the present invention described above is applicable to display devices of electronic devices in all fields that display a video signal input thereto or a video signal generated therein as an image or video. For example, a display device according to an embodiment of the present invention is applicable to display devices of various electronic devices shown in FIGS. 15 to 19G, such for example as digital cameras, notebook personal computers, portable terminal devices (e.g., mobile devices) such as portable telephones and the like, and video cameras.

By thus using a display device according to an embodiment of the present invention as display devices of electronic devices in all fields, novel image control can be performed on display images on various electronic devices. Specifically, as is clear from the description of the foregoing embodiments, novel image control that cannot be expected when the emission period is controlled uniformly over the entire screen is enabled by using a display device according to an embodiment of the present invention.

A display device according to an embodiment of the present invention includes a display device in the form of a sealed module. For example, a display module formed by attaching a counter part such as a transparent glass or the like to a pixel array section 30 corresponds to a display device in the form of a sealed module. This transparent counter part may be provided with a color filter, a protective film and the like, and a light shielding film as described above. Incidentally, the display module may be provided with a circuit part, an FPC (Flexible Printed Circuit) or the like for externally inputting or outputting a signal and the like to or from the pixel array section.

Concrete examples of electronic devices to which embodiments of the present invention are applied will be described in the following.

FIG. 15 is a perspective view of an external appearance of a television set to which one embodiment of the present invention is applied. The television set according to the present example of application includes a video display screen part 101 composed of a front panel 102, a filter glass 103 and the like, and is fabricated using a display device according to an embodiment of the present invention as the video display screen part 101.

FIGS. 16A and 16B are perspective views of an external appearance of a digital camera to which one embodiment of the present invention is applied. FIG. 16A is a perspective view of the digital camera as viewed from a front side, and FIG. 16B is a perspective view of the digital camera as viewed from a back side. The digital camera according to the present example of application includes a light emitting part 111 for flashlight, a display part 112, a menu switch 113, a shutter button 114, and the like. The digital camera is fabricated using a display device according to an embodiment of the present invention as the display part 112.

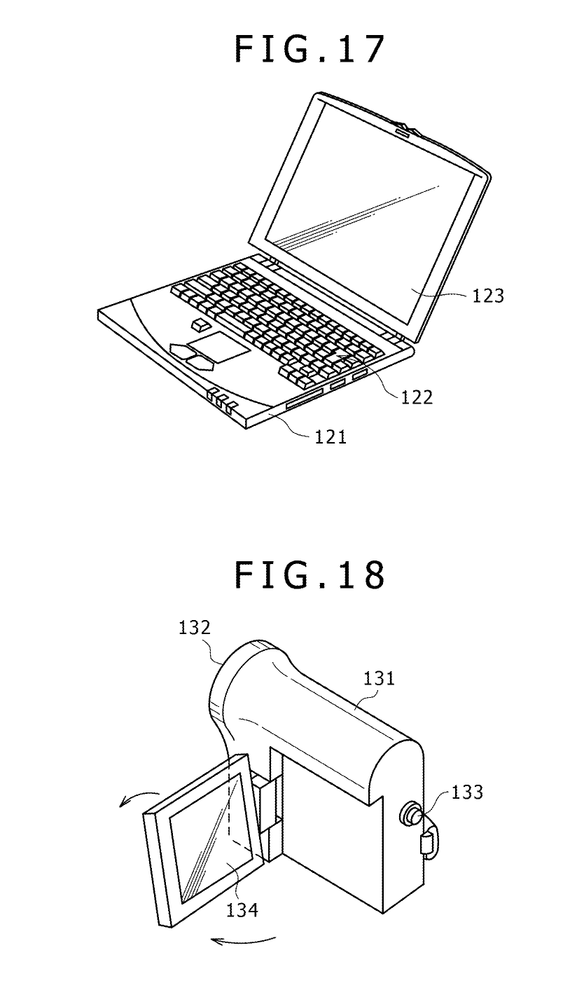

FIG. 17 is a perspective view of an external appearance of a notebook personal computer to which the present invention is applied. The notebook personal computer according to the present example of application includes a keyboard 122 operated to input characters and the like, a display part 123 for displaying an image, and the like in a main unit 121. The notebook personal computer is fabricated using a display device according to an embodiment of the present invention as the display part 123.

FIG. 18 is a perspective view of an external appearance of a video camera to which the present invention is applied. The video camera according to the present example of application includes a main unit 131, a lens 132 for taking a subject which lens is in a side surface facing frontward, a start/stop switch 133 at a time of picture taking, a display part 134, and the like. The video camera is fabricated using a display device according to an embodiment of the present invention as the display part 134.

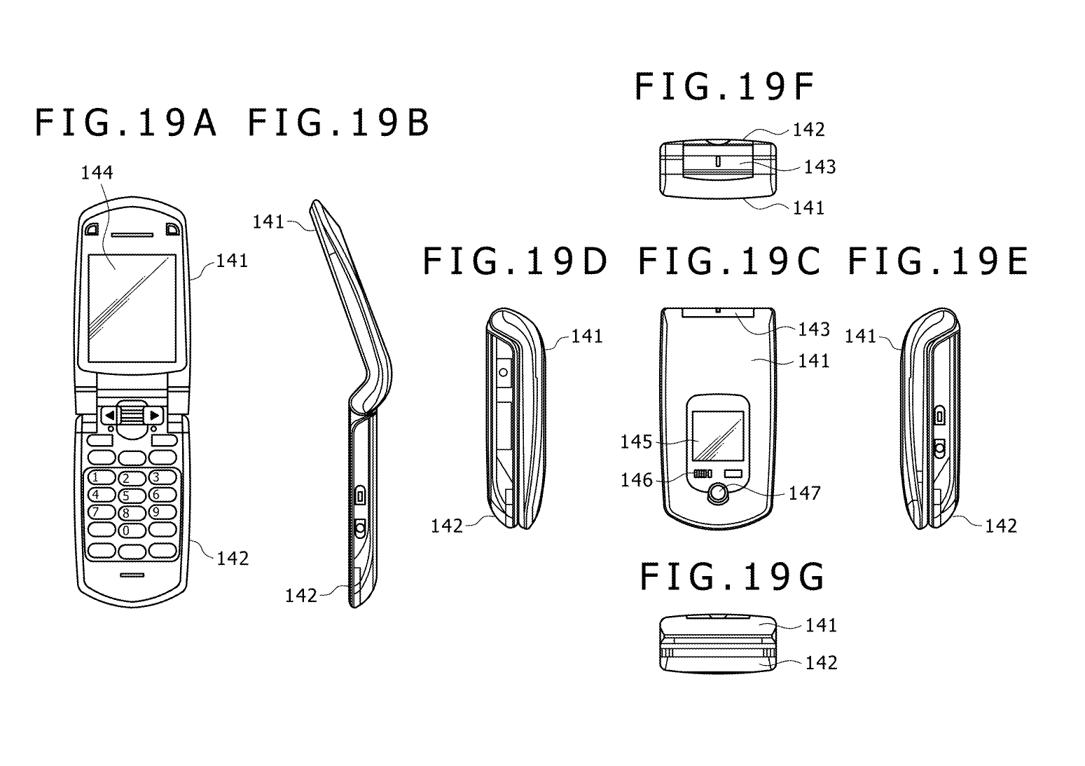

FIGS. 19A, 19B, 19C, 19D, 19E, 19F, and 19G are external views of a portable terminal device, for example a portable telephone to which the present invention is applied. FIG. 19A is a front view of the portable telephone in an opened state, FIG. 19B is a side view of the portable telephone in the opened state, FIG. 19C is a front view of the portable telephone in a closed state, FIG. 19D is a left side view, FIG. 19E is a right side view, FIG. 19F is a top view, and FIG. 19G is a bottom view. The portable telephone according to the present example of application includes an upper side casing 141, a lower side casing 142, a coupling part (a hinge part in this case) 143, a display 144, a sub-display 145, a picture light 146, a camera 147, and the like. The portable telephone according to the present example of application is fabricated using a display device according to an embodiment of the present invention as the display 144 and the sub-display 145.

The present application contains subject matter related to that disclosed in Japanese Priority Patent Application JP 2009-133607 filed in the Japan Patent Office on Jun. 3, 2009, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. An apparatus comprising:
a pixel to emit light, the pixel comprising:
a light-emitting element, and
a control circuit
to receive an input having a value that sets a time period for which the light-emitting element is to emit light, and
to control the light-emitting element to emit light for the time period.

2. The apparatus of claim 1, wherein the light-emitting element comprises an organic electro-luminescence element.

3. The apparatus of claim 1, wherein the pixel is coupled to:
a first line that provides power;
a second line that provides a signal setting an amount of light emitted by the light-emitting element; and
a third line that provides the input.

4. The apparatus of claim 1, wherein the control circuit comprises a writing transistor that controls storing the value in response to a scan signal.

5. The apparatus of claim 1, wherein the control circuit controls the light-emitting element to stop emitting light at the end of the time period.

6. The apparatus of claim 1, further comprising a display screen comprising a plurality of pixels.

7. The apparatus of claim 6, further comprising a driving circuit that provides inputs individually to the pixels to set time periods for which respective pixels emit light.

8. The apparatus of claim 7, wherein the pixels are arranged in an array comprising rows and columns, wherein the driving circuit comprises a row driving circuit and a column driving circuit.

9. The apparatus of claim 8, wherein the row driving circuit selects a row of pixels and the column driving circuit provides the inputs to the row of pixels.

10. The apparatus of claim 7, wherein the driving circuit provides a first input to a first pixel that sets a first time period and a second input to a second pixel that sets a second time period, the first time period being different from the second time period.

11. The apparatus of claim 7, wherein the driving circuit changes the inputs.

12. The apparatus of claim 1, wherein the time period has a shorter duration than a frame period for which an image is displayed on the display screen.

13. The apparatus of claim 1, wherein the input has a voltage that sets the time period.

14. The apparatus of claim 1, wherein the control circuit comprises a controlling transistor that allows current to be supplied to the light-emitting element for the time period.

15. The apparatus of claim 14, wherein the control circuit further comprises a capacitor that receives the input.

16. The apparatus of claim 15, wherein the capacitor provides a signal to a gate terminal of the controlling transistor.

17. The apparatus of claim 16, wherein the controlling transistor is an N-channel transistor, and wherein the capacitor and the gate terminal are coupled to ground via a resistor.

18. The apparatus of claim 16, wherein the controlling transistor is a P-channel transistor, and wherein the capacitor and the gate terminal are coupled to a power supply voltage via a resistor.

19. The apparatus of claim 1, wherein the pixel further comprises a drive transistor that drives the light-emitting element, and wherein the pixel compensates for variations in threshold voltage and carrier mobility of the drive transistor.

20. An apparatus comprising:
a driving circuit to control a plurality of pixels of a display screen to emit light by providing to each pixel a signal having a value that sets a length of time for which the pixel is to emit light, wherein the signal value for a first pixel is different from the signal value for a second pixel.

21. The apparatus of claim 20, wherein a line of pixels comprises the first pixel and the second pixel, wherein the driving circuit provides the first signal to the first pixel and the second signal to the second pixel.

22. The apparatus of claim 21, wherein the line of pixels is a row of pixels.

23. The apparatus of claim 21, wherein the line of pixels is a column of pixels.

24. The apparatus of claim 20, wherein the driving circuit provides a first signal to the first pixel using a first line and a second signal to the second pixel using a second line.

25. The apparatus of claim 20, wherein the driving circuit provides a scan signal that controls the pixels to store the signal values.

26. An apparatus comprising:
a display screen comprising a plurality of pixels, each pixel of the plurality of pixels comprising a light-emitting element to emit light; and
at least one driving circuit to control the plurality of pixels to emit light by providing to each pixel a signal having a value that sets a length of time for which the pixel is to emit light, wherein the signal value for a first pixel is different from the signal value for a second pixel.

27. The apparatus of claim 26, wherein the light-emitting element comprises an organic electro-luminescence element.

28. The apparatus of claim 26, wherein a line of pixels comprises the first pixel and the second pixel, wherein the driving circuit provides the first signal to the first pixel and the second signal to the second pixel.

29. The apparatus of claim 26, wherein the length of time is less than a frame period for which an image is displayed on the display screen.

30. An electronic device for displaying visual content to a user, the electronic device comprising:
a display screen comprising a plurality of pixels, each pixel of the plurality of pixels comprising a light-emitting element to emit light; and
at least one driving circuit to control the plurality of pixels to emit light by providing to each pixel a signal having a value that sets a length of time for which the pixel is to emit light, wherein the signal value for a first pixel is different from the signal value for a second pixel.

31. The electronic device of claim 30, wherein the light-emitting element comprises an organic electro-luminescence element.

32. The electronic device of claim 30, wherein the electronic device comprises at least one of a television, a digital camera, a computer, a video camera and a mobile device.

33. A method of operating a pixel to emit light, the method comprising:
receiving, at the pixel, a first input signaling that light is to be emitted and a second input having a value that sets a time period during which to emit light;
in response to the first input, emitting light from a light-emitting element of the pixel; and
following the time period, ceasing to emit light from the light-emitting element.

34. The method of claim 33, wherein light is emitted by a plurality of pixels.

35. The method of claim 34, wherein a first pixel emits light for a different amount of time than a second pixel emits light.

36. The method of claim 33, wherein light is emitted by the pixel for a duration shorter than a frame period for which an image is displayed.

37. A method of displaying an image on a display device, the display device comprising a plurality of pixels, the method comprising:
operating a set of pixels of the display device to emit light, wherein operating the set comprises:
configuring a first pixel of the set to emit light for a first time period;
configuring a second pixel of the set to emit light for a second time period, the first time period being different from the second time period; and
controlling each pixel of the set of pixels to emit light.

38. The method of claim 37, wherein a line of pixels comprises the first pixel and the second pixel.

39. The method of claim 38, wherein the first and second pixels emit light at the same time.

40. The method of claim 37, further comprising providing a first value to the first pixel that sets the first time period and a second value to the second pixel that sets the second time period, wherein the first value is different from the second value.

41. The method of claim 40, further comprising controlling the first pixel to store the first value and the second pixel to store the second value.

42. The method of claim 37, wherein the first and second pixels have different duty cycles for light emission.

43. The method of claim 37, further comprising changing the first time period.
